(19) United States
(12) Patent Application Publication
(10) Pub. No.: US 2001/0038710 A1
(43) Pub. Date: Nov. 8, 2001

(54) Process and apparatus for conversion of continuous tone input image data into halftone output image data with correction based on characteristics of input and output devices

(76) Inventors: Michiko Kawano, Kawasaki-shi (JP); Hiroyuki Endo, kawasaki-shi (JP); Taeko Koizumi, Kawasaki-shi (JP); Akiko Kitami, Kawasaki-shi (JP); Yuko Suzuki, Kawasaki-shi (JP)

Correspondence Address: STAAS & HALSEY LLP, 700 11TH STREET, NW, SUITE 500, WASHINGTON, DC, 20001, US

(21) Appl. No.: 09/740,935

(22) Filed: Dec. 21, 2000

Related U.S. Application Data
(62) Division of application No. 09/333,519, filed on Jun. 15, 1999, now abandoned.
Application No. 09/333,519 is a division of application No. 08/588,917, filed on Jan. 19, 1996, now abandoned.

(30) Foreign Application Priority Data
Jan. 19, 1995 (JP) 07-006171

(51) Int. Cl. G06K 9/38; G06K 9/00

(52) U.S. Cl. 382/172

(57) ABSTRACT

A process and an apparatus for converting multi-valued image data obtained, for a plurality of pixels of a continuous tone image, by an image input device, into binary image data representing a halftone image to be output by an image output device. The conversion is performed by comparing the multi-valued image data for the plurality of pixels with threshold values, which are determined in advance so as to be specific to a combination of the image input device and the image output device. Alternatively, the multi-valued image data may be corrected before comparison with threshold values, by using correction data which is determined in advance so as to be specific to a combination of the image input device and the image output device.

### BACKGROUND OF THE INVENTION

(1) Field of the Invention

The present invention relates to a process and an apparatus for producing a threshold value pattern (halftone dot pattern) which is used for converting multi-valued image data representing a continuous tone image into binary image data representing a halftone image. In addition, the present invention relates to a process and an apparatus for converting multi-valued image data representing a continuous tone image into binary image data representing a halftone image, by using a threshold value pattern.

The halftone printing is widely used for printing multi-valued image data. When printing multi-valued image data as a halftone print image, multi-valued image data must be converted to binary image data. This conversion is typically carried out by comparing the multi-valued image data of each pixel with a threshold value for the pixel, which is provided in a threshold value pattern. Several methods are known for converting multi-valued image data into binary image data by using a threshold value pattern. The present invention is applicable to all of these methods. The dither method is one of such methods for converting multi-valued image data into binary image data by using a threshold value pattern. Hereinafter, in this specification, the explanations are provided for the cases using the dither method. However, persons skilled in the art will understand that the present invention can be applied to any other method substantially in the same manner as explained in this specification.

(2) Description of the Related Art

FIG. 1 illustrates an example process of converting multi-value image data into binary image data by the dither method. The threshold value pattern, which is indicated in the center of FIG. 1, contains threshold values of density or lightness values for respective pixels of input image data. As indicated in FIG. 1, when the value of the input image data of a pixel is greater than the threshold value for the pixel, which is provided in the threshold value pattern, the value of the input image data is converted to a binary value “1”, and when the value of the input image data of a pixel is smaller than the threshold value for the pixel, which is provided in the threshold value pattern, the value of the input image data is converted to a binary value “0”.

Often, the above multi-valued input image data is produced by scanning a continuous tone image printed or written on paper, by an image input device such as an image scanner, and the above converted binary image data is usually output by an image output device, for example, is printed on paper by a printer. Generally, image data which is produced by an image input device such as an image scanner, is expected to indicate density or lightness of an original image, where the image input device detects the density or lightness by scanning the original image. However, usually, the image data does not precisely indicate a real density or lightness value of the original image. The relationship between the real density or lightness value of an original image and the image data generated by scanning the original image by an image input device, indicates detection characteristics of the image input device. Since the input image data is converted to binary image data by using a threshold value pattern, i.e., by comparing the input image data value with a predetermined threshold value for each pixel, the difference between the real density or lightness value of the original image and the image data generated by scanning the original image by the image input device, affects the quality of the resultant halftone image. In addition, in an image output device such as a printer, the actual density or lightness of the output (printed) image may differ from a theoretical density or lightness value which is supplied to the image output device, and this difference also affects the quality of the resultant halftone image. The relationship between the theoretical density or lightness value which is supplied to the image output device and the real density or lightness value of the output image indicates the output (printing) characteristics of the image output device.

Conventionally, the conversion from input image data into binary image data is performed regardless of the detection characteristics of the image input device and the output characteristics of the image output device. In particular, the threshold value pattern used for the conversion is produced regardless of the detection characteristics of the image input device and the output characteristics of the image output device. For example, when the threshold value pattern for use in conversion of 256-valued data containing 10×10 elements is produced, first, a basic pattern is produced by allocating the numbers 1 to 100 to predetermined elements in the matrix of 10×10 as indicated in FIG. 2. Then, the allocated numbers 1 to 100 are replaced with threshold values in the range of 0 to 255 so that in the respective elements in the matrix, the replaced threshold values are proportional to the above allocated numbers 1 to 100 before replacement. Thus, a threshold value pattern as indicated in FIG. 3 is obtained. Since, conventionally, the threshold value pattern is fixed, and no other adjustment is performed in a system carrying out the conversion, the adjustment of the quality of the output image is performed manually by trial and error. That is, when the output image does not seem satisfactory for a user, the user manually shifts levels of all of the input image data, and retries the halftone printing. Therefore, conventional halftone printing is very bothersome, and the quality of the resultant halftone image depends on experienced user's special know-how and skill.

### SUMMARY OF THE INVENTION

A first object of the present invention is to provide a process and an apparatus for producing a threshold value pattern which is used for converting multi-valued image data into binary image data such that by using the threshold value pattern, deterioration of an output image due to the detection characteristics of the image input device can easily be avoided.

A second object of the present invention is to provide a process and an apparatus for producing a threshold value pattern which is used for converting multi-valued image data into binary image data such that by using the threshold value pattern, deterioration of an output image due to the output characteristics of the image output device can easily be avoided.

A third object of the present invention is to provide a process and an apparatus for producing a threshold value pattern which is used for converting multi-valued image data into binary image data such that by using the threshold value pattern, deterioration of an output image due to the detection characteristics of the image input device and the output characteristics of the image output device can easily be avoided.

A fourth object of the present invention is to provide a process and an apparatus for converting multi-valued image data into binary image data by using a threshold value pattern such that deterioration of an output image due to the detection characteristics of the image input device can easily be avoided.

A fifth object of the present invention is to provide a process and an apparatus for converting multi-valued image data into binary image data by using a threshold value pattern such that deterioration of an output image due to the output characteristics of the image output device can easily be avoided.

A sixth object of the present invention is to provide a process and an apparatus for converting multi-valued image data into binary image data by using a threshold value pattern such that deterioration of an output image due to the detection characteristics of the image input device and the output characteristics of the image output device can easily be avoided.

According to the first aspect of the present invention, there is provided a process and an apparatus for producing a threshold value pattern which is used for converting multi-valued image data into binary image data.

(1) According to the first aspect of the present invention, there is provided a process for producing a threshold value pattern which is used for converting multi-valued image data into binary image data, where the multi-valued image data is obtained for a plurality of pixels by an image input device which detects a predetermined one of density and lightness of each pixel of an original image. This process contains the steps of: (a) obtaining information on a detection characteristic for the predetermined one of density and lightness in the image input device; (b) obtaining a basic threshold value pattern containing a plurality of elements which indicate threshold values for the plurality of pixels; and (c) converting the threshold values into corrected threshold values for the plurality of pixels, respectively, based on the information on the detection characteristic.

(1-1) In the process according to the first aspect of the present invention, the information may be obtained by measuring densities of a plurality of sample images by both the image input device and another device for measuring the predetermined one of density and lightness with high accuracy, and obtaining a relationship between a plurality of first values of the predetermined one of density and lightness for the plurality of pixels obtained by measurement by the image input device and a plurality of second values of the predetermined one of density and lightness for the plurality of pixels obtained by measurement by the another device.

(1-2) In the process according to (1-1), the step (c) may contain the sub-steps of (c1) generating a conversion table for converting the threshold values into the corrected threshold values for the plurality of pixels, respectively, based on the relationship, and (c2) converting the threshold values into the corrected threshold values for the plurality of pixels by using the conversion table.

(2) According to the second aspect of the present invention, there is provided an apparatus for producing a threshold value pattern which is used for converting multi-valued image data into binary image data, where the multi-valued image data is obtained for a plurality of pixels by an image input device which detects a predetermined one of density and lightness of each pixel of an original image. This apparatus contains: a characteristic information input unit for inputting information on a detection characteristic for the predetermined one of density and lightness in the image input device; a basic threshold value pattern obtaining unit for obtaining a basic threshold value pattern containing a plurality of elements which indicate threshold values for the plurality of pixels; and a conversion unit for converting the threshold values into corrected threshold values for the plurality of pixels, respectively, based on the information on the detection characteristic.

(2-1) In the apparatus according to the second aspect of the present invention, the information may be obtained by measuring densities of a plurality of sample images by both the image input device and another device for measuring the predetermined one of density and lightness with high accuracy, and obtaining a relationship between a plurality of first values of the predetermined one of density and lightness for the plurality of pixels obtained by measurement by the image input device and a plurality of second values of the predetermined one of density and lightness for the plurality of pixels obtained by measurement by the another device.

(2-2) The apparatus according to (2-1) may further contain a unit for generating a conversion table for converting the threshold values into the corrected threshold values for the plurality of pixels, respectively, based on the relationship, and a conversion unit converts the threshold values into the corrected threshold values for the plurality of pixels by using the conversion table.

(3) According to the third aspect of the present invention, there is provided a computer-readable storage medium in which a program is stored, where the program, when used with a computer, directs the computer to execute a process for producing a threshold value pattern which is used for converting multi-valued image data into binary image data, where the multi-valued image data is obtained for a plurality of pixels by an image input device which detects a predetermined one of density and lightness of each pixel of an original image. This process contains the steps of: (a) obtaining information on a detection characteristic for the predetermined one of density and lightness in the image input device; (b) obtaining a basic threshold value pattern containing a plurality of elements which indicate threshold values for the plurality of pixels; and (c) converting the threshold values into corrected threshold values for the plurality of pixels, respectively, based on the information on the detection characteristic.

(3-1) In the computer-readable storage according to the third aspect of the present invention, the information may be obtained by measuring densities of a plurality of sample images by both the image input device and another device for measuring the predetermined one of density and lightness with high accuracy, and obtaining a relationship between a plurality of first values of the predetermined one of density and lightness for the plurality of pixels obtained by measurement by the image input device and a plurality of second values of the predetermined one of density and lightness for the plurality of pixels obtained by measurement by the another device.

(3-2) In the computer-readable storage of (3-1), step (c) may contain the sub-steps of: (c1) generating a conversion table for converting the threshold values into the corrected threshold values for the plurality of pixels, respectively, based on the relationship, and (c2) converting the threshold values into the corrected threshold values for the plurality of pixels by using the conversion table.

(4) According to the fourth aspect of the present invention, there is provided a process for producing a threshold value pattern which is used for converting multi-valued image data for a plurality of pixels into binary image data, where the binary image data is to be output as a visible output image by an image output device. This process contains the steps of: (a) obtaining information on an output characteristic of the image output device; (b) obtaining a basic threshold value pattern containing a plurality of elements which indicate threshold values for the plurality of pixels; and (c) converting the threshold values into corrected threshold values for the plurality of pixels, respectively, based on the information on the output characteristic.

(4-1) In the process according to the fourth aspect of the present invention, the information may be obtained by measuring an actual size of a dot which is output by the image output device in correspondence with a theoretical size of the dot to obtain as a dot gain a ratio of the actual dot size to the theoretical dot size. In addition, in step (c), the conversion of the threshold values into the corrected threshold values is performed based on the dot gain.

(4-2) In the above process of (4-1), step (c) may further contain the sub-step of, (c1) obtaining a plurality of actual halftone dot ratios for a plurality of theoretical halftone dot ratios based on the dot gain, to obtain a first relationship between the plurality of actual-halftone dot ratios and the plurality of theoretical halftone dot ratios.

(4-3) In the above process of (4-2), step (c) may further contain the sub-steps of, (c2) obtaining a first reference value of the predetermined one of density and lightness of a background area of the visible output image, and a second reference value of the predetermined one of density and lightness of an area within the dot, (c3) calculating a plurality of values of the predetermined one of density and lightness for the plurality of the theoretical halftone dot ratios based on the first and second reference values, to obtain a second relationship between the plurality of values of the predetermined one of density and lightness and the plurality of the theoretical halftone dot ratios, (c4) obtaining a third relationship between a plurality of theoretical values of the predetermined one of density and lightness and a plurality of actual values of the predetermined one of density and lightness based on the first and second relationships, and (c5) converting the threshold values into the corrected threshold values for the plurality of pixels, respectively, based on the third relationship.

(4-4) In the above process of (4-3), step (c5) may further contain the sub-steps of, (c6) generating a conversion table for converting the threshold values into the corrected threshold values for the plurality of pixels, respectively, based on the third relationship, and (c7) converting the threshold values into the corrected threshold values for the plurality of pixels by using the conversion table.

(5) According to the fifth aspect of the present invention, there is provided an apparatus for producing a threshold value pattern which is used for converting multi-valued image data for a plurality of pixels into binary image data, where the binary image data is to be output as a visible output image by an image output device. This apparatus contains: a characteristic information input unit for inputting information on an output characteristic of the image output device; a basic threshold value pattern obtaining unit for obtaining a basic threshold value pattern containing a plurality of elements which indicate threshold values for the plurality of pixels; and a conversion unit for converting the threshold values into corrected threshold values for the plurality of pixels, respectively, based on the information on the output characteristic.

(5-1) In the apparatus according to the fifth aspect of the present invention, the information may be obtained by measuring an actual size of a dot which is output by the image output device in correspondence with a theoretical size of the dot to obtain as a dot gain a ratio of the actual dot size to the theoretical dot size. In addition, the conversion of the threshold values into the corrected threshold values is performed by the conversion unit based on the dot gain.

(5-2) The apparatus of (5-1) may further contain a unit for obtaining a plurality of actual halftone dot ratios for a plurality of theoretical halftone dot ratios based on the dot gain, to obtain a first relationship between the plurality of actual halftone dot ratios and the plurality of theoretical halftone dot ratios.

(5-3) In the apparatus of (5-2), step (c) may further contain a reference obtaining unit for obtaining a first reference value of the predetermined one of density and lightness of a background area of the visible output image, and a second reference value of the predetermined one of density and lightness of an area within the dot, and a calculating unit for calculating a plurality of values of the predetermined one of density and lightness for the plurality of the theoretical halftone dot ratios based on the first and second reference values, to obtain a second relationship between the plurality of values of the predetermined one of density and lightness and the plurality of the theoretical halftone dot ratios, and a conversion relationship obtaining unit for obtaining a third relationship between a plurality of theoretical values of the predetermined one of density and lightness and a plurality of actual values of the predetermined one of density and lightness based on the first and second relationships, and a the conversion unit converts the threshold values into the corrected threshold values for the plurality of pixels, respectively, based on the third relationship.

(5-4) In the apparatus of (5-3), the conversion unit may further contain a unit for generating a conversion table for converting the threshold values into the corrected threshold values for the plurality of pixels, respectively, based on the third relationship, and a unit for converting the threshold values into the corrected threshold values for the plurality of pixels by using the conversion table.

(6) According to the sixth aspect of the present invention, there is provided a computer-readable storage medium in which a program is stored, where the program, when used with a computer, directs the computer to execute a process for producing a threshold value pattern which is used for converting multi-valued image data for a plurality of pixels into binary image data, where the binary image data is to be output as a visible output image by an image output device. This process contains the steps of: (a) obtaining information on an output characteristic of the image output device; (b) obtaining a basic threshold value pattern containing a plurality of elements which indicate threshold values for the plurality of pixels; and (c) converting the threshold values into corrected threshold values for the plurality of pixels, respectively, based on the information on the output characteristic.

(6-1) In the computer-readable storage according to the sixth aspect of the present invention, the information may be obtained by measuring an actual size of a dot which is output by the image output device in correspondence with a theoretical size of the dot to obtain as a dot gain a ratio of the actual dot size to the theoretical dot size. In addition, in step (c), the conversion of the threshold values into the corrected threshold values is performed based on the dot gain.

(6-2) In the computer-readable storage of (6-1), step (c) may further contain the sub-step of, (c1) obtaining a plurality of actual halftone dot ratios for a plurality of theoretical halftone dot ratios based on the dot gain, to obtain a first relationship between the plurality of actual halftone dot ratios and the plurality of theoretical halftone dot ratios.

(6-3) In the computer-readable storage of (6-2), step (c) may further contain the sub-steps of, (c2) obtaining a first reference value of the predetermined one of density and lightness of a background area of the visible output image, and a second reference value of the predetermined one of density and lightness of an area within the dot, (c3) calculating a plurality of values of the predetermined one of density and lightness for the plurality of the theoretical halftone dot ratios based on the first and second reference values, to obtain a second relationship between the plurality of values of the predetermined one of density and lightness and the plurality of the theoretical halftone dot ratios, (c4) obtaining a third relationship between a plurality of theoretical values of the predetermined one of density and lightness and a plurality of actual values of the predetermined one of density and lightness based on the first and second relationships, and (c5) converting the threshold values into the corrected threshold values for the plurality of pixels, respectively, based on the third relationship.

(6-4) In the computer-readable storage of (6-3), step (c5) may further contain the sub-steps of, (c6) generating a conversion table for converting the threshold values into the corrected threshold values for the plurality of pixels, respectively, based on the third relationship, and (c7) converting the threshold values into the corrected threshold values for the plurality of pixels by using the conversion table.

(7) According to the seventh aspect of the present invention, there is provided a process for producing a threshold value pattern which is used for converting multi-valued image data into binary image data, where the multi-valued image data is obtained for a plurality of pixels by an image input device which detects a predetermined one of density and lightness of each pixel of an original image, and the binary image data is to be output as a visible output image by an image output device. This process contains the steps of: (a) obtaining first information on a detection characteristic for the predetermined one of density and lightness in the image input device; (b) obtaining second information on an output characteristic of the image output device; (c) obtaining a basic threshold value pattern containing a plurality of elements which indicate threshold values for the plurality of pixels; and (d) converting the threshold values into corrected threshold values for the plurality of pixels, respectively, based on the first and second information.

(7-1) In the process according to the seventh aspect of the present invention, the first information may be obtained by measuring densities of a plurality of sample images by both the image input device and another device for measuring the predetermined one of density and lightness with high accuracy, and obtaining a first relationship between a plurality of first values of the predetermined one of density and lightness for the plurality of pixels obtained by measurement by the image input device and a plurality of second values of the predetermined one of density and lightness for the plurality of pixels obtained by measurement by the another device.

(7-2) In the process of (7-1), the information may be obtained by measuring an actual size of a dot which is output by the image output device in correspondence with a theoretical size of the dot to obtain as a dot gain a ratio of the actual dot size to the theoretical dot size. In addition, in step (d), the conversion of the threshold values into the corrected threshold values is performed based on the first relationship and the dot gain.

(7-3) In the process of (7-2), step (d) may contain the sub-steps of, (d1) generating a conversion table for converting the threshold values into the corrected threshold values for the plurality of pixels, respectively, based on the first relationship and the dot gain, and (d2) converting the threshold values into the corrected threshold values for the plurality of pixels by using the conversion table.

(7-4) In the process of (7-2), step (d) may further contain the sub-step of, (d3) obtaining a plurality of actual halftone dot ratios for a plurality of theoretical halftone dot ratios based on the dot gain, to obtain a second relationship between the plurality of actual halftone dot ratios and the plurality of theoretical halftone dot ratios.

(7-5) In the process of (7-4), step (d) may further contain the sub-steps of, (d4) obtaining a first reference value of the predetermined one of density and lightness of a background area of the visible output image, and a second reference value of the predetermined one of density and lightness of an area within the dot, and (d5) calculating a plurality of values of the predetermined one of density and lightness for the plurality of the theoretical halftone dot ratios based on the first and second reference values, to obtain a third relationship between the plurality of values of the predetermined one of density and lightness and the plurality of the theoretical halftone dot ratios, (d6) obtaining a fourth relationship between a plurality of theoretical values of the predetermined one of density and lightness and a plurality of actual values of the predetermined one of density and lightness based on the second and third relationships, (d7) obtaining a fifth relationship between the plurality of first values of the predetermined one of density and lightness for the plurality of pixels obtained by measurement by the image input device, and the plurality of theoretical values of the predetermined one of density and lightness, based on the first and fourth relationship, and (d8) converting the threshold values into the corrected threshold values for the plurality of pixels, respectively, based on the fifth relationship.

(7-6) In the process of (7-5), step (d8) may further contain the sub-steps of, (d9) generating a conversion table for converting the threshold values into the corrected threshold values for the plurality of pixels, respectively, based on the fifth relationship, and (d10) converting the threshold values into the corrected threshold values for the plurality of pixels by using the conversion table.

(8) According to the eighth aspect of the present invention, there is provided an apparatus for producing a threshold value pattern which is used for converting multi-valued image data into binary image data, where the multi-valued image data is obtained for a plurality of pixels by an image input device which detects a predetermined one of density and lightness of each pixel of an original image, and the binary image data is to be output as a visible output image by an image output device. This apparatus contains: a first information obtaining unit for obtaining first information on a detection characteristic for the predetermined one of density and lightness in the image input device; a second information obtaining unit for obtaining second information on an output characteristic of the image output device; a basic threshold value pattern obtaining unit for obtaining a basic threshold value pattern containing a plurality of elements which indicate threshold values for the plurality of pixels; and a conversion unit for converting the threshold values into corrected threshold values for the plurality of pixels, respectively, based on the first and second information.

(8-1) In the apparatus according to the eighth aspect of the present invention, the first information may be obtained by measuring densities of a plurality of sample images by both the image input device and another device for measuring the predetermined one of density and lightness with high accuracy, and obtaining a first relationship between a plurality of first values of the predetermined one of density and lightness for the plurality of pixels obtained by measurement by the image input device and a plurality of second values of the predetermined one of density and lightness for the plurality of pixels obtained by measurement by the another device.

(8-2) In the apparatus of (8-1), the information may be obtained by measuring an actual size of a dot which is output by the image output device in correspondence with a theoretical size of the dot to obtain as a dot gain a ratio of the actual dot size to the theoretical dot size. In addition, in the conversion unit, the conversion of the threshold values into the corrected threshold values is performed based on the first relationship and the dot gain.

(8-3) In the apparatus of (8-2), the conversion unit may contain a unit for generating a conversion table for converting the threshold values into the corrected threshold values for the plurality of pixels, respectively, based on the first relationship and the dot gain, and a unit for converting the threshold values into the corrected threshold values for the plurality of pixels by using the conversion table.

(8-4) The apparatus of (8-3) may further contain a unit for obtaining a plurality of actual halftone dot ratios for a plurality of theoretical halftone dot ratios based on the dot gain, to obtain a second relationship between the plurality of actual halftone dot ratios and the plurality of theoretical halftone dot ratios.

(8-5) In the apparatus of (8-4), the conversion unit may further contain a unit for obtaining a first reference value of the predetermined one of density and lightness of a background area of the visible output image, and a second reference value of the predetermined one of density and lightness of an area within the dot, and a unit for calculating a plurality of values of the predetermined one of density and lightness for the plurality of the theoretical halftone dot ratios based on the first and second reference values, to obtain a third relationship between the plurality of values of the predetermined one of density and lightness and the plurality of the theoretical halftone dot ratios, a unit for obtaining a fourth relationship between a plurality of theoretical values of the predetermined one of density and lightness and a plurality of actual values of the predetermined one of density and lightness based on the second and third relationships, a unit for obtaining a fifth relationship between the plurality of first values of the predetermined one of density and lightness for the plurality of pixels obtained by measurement by the image input device, and the plurality of theoretical values of the predetermined one of density and lightness, based on the first and fourth relationship, and a unit for converting the threshold values into the corrected threshold values for the plurality of pixels, respectively, based on the fifth relationship.

(8-6) In the apparatus of (8-5), the unit for converting, may further contain a unit for generating a conversion table for converting the threshold values into the corrected threshold values for the plurality of pixels, respectively, based on the fifth relationship, and a unit for converting the threshold values into the corrected threshold values for the plurality of pixels by using the conversion table.

(9) According to the ninth aspect of the present invention, there is provided a computer-readable storage medium in which a program is stored, where the program, when used with a computer, directs the computer to execute a process for producing a threshold value pattern which is used for converting multi-valued image data into binary image data, where the multi-valued image data is obtained for a plurality of pixels by an image input device which detects a predetermined one of density and lightness of each pixel of an original image, and the binary image data is to be output as a visible output image by an image output device. This process contains the steps of: (a) obtaining first information on a detection characteristic for the predetermined one of density and lightness in the image input device; (b) obtaining second information on an output characteristic of the image output device; (c) obtaining a basic threshold value pattern containing a plurality of elements which indicate threshold values for the plurality of pixels; and (d) converting the threshold values into corrected threshold values for the plurality of pixels, respectively, based on the first and second information.

(9-1) In the computer-readable storage according to the ninth aspect of the present invention, the first information may be obtained by measuring densities of a plurality of sample images by both the image input device and another device for measuring the predetermined one of density and lightness with high accuracy, and obtaining a first relationship between a plurality of first values of the predetermined one of density and lightness for the plurality of pixels obtained by measurement by the image input device and a plurality of second values of the predetermined one of density and lightness for the plurality of pixels obtained by measurement by the another device.

(9-2) In the computer-readable storage of (9-1), the information may be obtained by measuring an actual size of a dot which is output by the image output device in correspondence with a theoretical size of the dot to obtain as a dot gain a ratio of the actual dot size to the theoretical dot size. In addition, in step (d), the conversion of the threshold values into the corrected threshold values is performed based on the first relationship and the dot gain.

(9-3) In the computer-readable storage of (9-2), step (d) may contain the sub-steps of, (d1) generating a conversion table for converting the threshold values into the corrected threshold values for the plurality of pixels, respectively, based on the first relationship and the dot gain, and (d2) converting the threshold values into the corrected threshold values for the plurality of pixels by using the conversion table.

(9-4) In the computer-readable storage of (9-2), step (d) may further contain the sub-step of, (d3) obtaining a plurality of actual halftone dot ratios for a plurality of theoretical halftone dot ratios based on the dot gain, to obtain a second relationship between the plurality of actual halftone dot ratios and the plurality of theoretical halftone dot ratios.

(9-5) In the computer-readable storage of (9-3), step (d) may further contain the sub-steps of, (d4) obtaining a first reference value of the predetermined one of density and lightness of a background area of the visible output image, and a second reference value of the predetermined one of density and lightness of an area within the dot, and (d5) calculating a plurality of values of the predetermined one of density and lightness for the plurality of the theoretical halftone dot ratios based on the first and second reference values, to obtain a third relationship between the plurality of values of the predetermined one of density and lightness and the plurality of the theoretical halftone dot ratios, (d6) obtaining a fourth relationship between a plurality of theoretical values of the predetermined one of density and lightness and a plurality of actual values of the predetermined one of density and lightness based on the second and third relationships, (d7) obtaining a fifth relationship between the plurality of first values of the predetermined one of density and lightness for the plurality of pixels obtained by measurement by the image input device, and the plurality of theoretical values of the predetermined one of density and lightness, based on the first and fourth relationship, and (d8) converting the threshold values into the corrected threshold values for the plurality of pixels, respectively, based on the fifth relationship.

(9-6) In the computer-readable storage of (9-5), step (d8) may further contain the sub-steps of, (d9) generating a conversion table for converting the threshold values into the corrected threshold values for the plurality of pixels, respectively, based on the fifth relationship, and (d10) converting the threshold values into the corrected threshold values for the plurality of pixels by using the conversion table.

(10) According to the tenth aspect of the present invention, there is provided a process for converting multi-valued image data into binary image data, where the multi-valued image data is obtained for a plurality of pixels by an image input device which detects a predetermined one of density and lightness of each pixel of an original image. This process contains the steps of: (a) inputting the multi-valued image data; and (b) converting the multi-valued image data for the plurality of pixels into the binary image data for the plurality of pixels by respectively comparing the multi-valued image data for the plurality of pixels with threshold values, which are determined in advance so as to be specific to the image input device.

(10-1) In the process according to the tenth aspect of the present invention, the threshold values may be generated in advance so that a detection characteristic for the predetermined one of density and lightness in the image input device is reflected therein.

(11) According to the eleventh aspect of the present invention, there is provided a process for converting multi-valued image data into binary image data, where the multi-valued image data is obtained for a plurality of pixels by one of a plurality of image input devices, and the one of the plurality of image input devices detects a predetermined one of density and lightness of each pixel of an original image. This process contains the steps of: (a) inputting the multi-valued image data; (b) inputting an instruction which indicates by which one of the plurality of image input devices the multi-valued image data is obtained; (c) selecting one of a plurality of threshold value patterns in response to the instruction, where each of the plurality of threshold value patterns contains a plurality of elements which indicate threshold values for the plurality of pixels, and is determined in advance so as to be specific to a respective one of the plurality of image input devices; and (d) converting the multi-valued image data for the plurality of pixels into the binary image data for the plurality of pixels by respectively comparing the multi-valued image data for the plurality of pixels with threshold values which are contained in the one of the plurality of threshold value patterns selected in step (c).

(12) According to the twelfth aspect of the present invention, there is provided an apparatus for converting multi-valued image data into binary image data, where the multi-valued image data is obtained for a plurality of pixels by an image input device which detects a predetermined one of density and lightness of each pixel of an original image. This apparatus contains: a data inputting unit for inputting the multi-valued image data; and a conversion unit for converting the multi-valued image data for the plurality of pixels into the binary image data for the plurality of pixels by respectively comparing the multi-valued image data for the plurality of pixels with threshold values, which are determined in advance so as to be specific to the image input device.

(12-1) In the apparatus according to the twelfth aspect of the present invention, the threshold values may be generated in advance so that a detection characteristic for the predetermined one of density and lightness in the image input device is reflected therein.

(13) According to the thirteenth aspect of the present invention, there is provided an apparatus for converting multi-valued image data into binary image data, where the multi-valued image data is obtained for a plurality of pixels by one of a plurality of image input devices, and the one of the plurality of image input devices detects a predetermined one of density and lightness of each pixel of an original image. This apparatus contains: a threshold value pattern storing unit for storing a plurality of threshold value patterns each containing a plurality of elements which indicate threshold values for the plurality of pixels, and each is determined in advance so as to be specific to a respective one of the plurality of image input devices; a data inputting unit for inputting the multi-valued image data; an instruction inputting unit for inputting an instruction which indicates by which one of the plurality of image input devices the multi-valued image data is obtained; a selection unit for selecting one of the plurality of threshold value patterns in response to the instruction; and a conversion unit for converting the multi-valued image data for the plurality of pixels into the binary image data for the plurality of pixels by respectively comparing the multi-valued image data for the plurality of pixels with the threshold values which are contained in the one of the plurality of threshold value patterns selected by the selection unit.

(14) According to the fourteenth aspect of the present invention, there is provided a computer-readable storage medium in which a program is stored, where the program, when used with a computer, directs the computer to execute a process for converting multi-valued image data into binary image data, where the multi-valued image data is obtained for a plurality of pixels by an image input device which detects a predetermined one of density and lightness of each pixel of an original image. This process contains the steps of: (a) inputting the multi-valued image data; (b) inputting an instruction which indicates by which one of the plurality of image input devices the multi-valued image data is obtained; (c) selecting one of a plurality of threshold value patterns in response to the instruction, where each of the plurality of threshold value patterns contains a plurality of elements which indicate threshold values for the plurality of pixels, and is determined in advance so as to be specific to a respective one of the plurality of image input devices; and (d) converting the multi-valued image data for the plurality of pixels into the binary image data for the plurality of pixels by respectively comparing the multi-valued image data for the plurality of pixels with threshold values which are contained in the one of the plurality of threshold value patterns selected in step

(15) According to the fifteenth aspect of the present invention, there is provided a process for converting multi-valued image data into binary image data, where the binary image data is to be output as a visible output image by an image output device. This process contains the steps of: (a) inputting the multi-valued image data; and (b) converting the multi-valued image data for the plurality of pixels into the binary image data for the plurality of pixels by respectively comparing the multi-valued image data for the plurality of pixels with threshold values, which are determined in advance so as to be specific to the image output device.

(15-1) In the process according to the fifteenth aspect of the present invention, the threshold values may be generated in advance so that an output characteristic of the image output device is reflected therein.

(16) According to the sixteenth aspect of the present invention, there is provided a process for converting multi-valued image data into binary image data, where the binary image data is to be output as a visible output image by one of a plurality of image output devices. This process contains the steps of: (a) inputting the multi-valued image data; (b) inputting an instruction which indicates by which one of the plurality of image output devices the binary image data is to be output; (c) selecting one of a plurality of threshold value patterns in response to the instruction, where each of the plurality of threshold value patterns contains a plurality of elements which indicate threshold values for the plurality of pixels, and is determined in advance so as to be specific to a respective one of the plurality of image output devices; and (d) converting the multi-valued image data for the plurality of pixels into the binary image data for the plurality of pixels-by respectively comparing the multi-valued image data for the plurality of pixels with the threshold values which are contained in the one of the plurality of threshold value patterns selected in step (c).

(17) According to the seventeenth aspect of the present invention, there is provided an apparatus for converting multi-valued image data into binary image data, where the binary image data is to be output as a visible output image by an image output device. This apparatus contains: a data inputting unit for inputting the multi-valued image data; and a conversion unit for converting the multi-valued image data for the plurality of pixels into the binary image data for the plurality of pixels by respectively comparing the multi-valued image data for the plurality of pixels with threshold values, which are determined in advance so as to be specific to the image output device.

(17-1) In the apparatus according to the seventeenth aspect of the present invention, the threshold values may be generated in advance so that an output characteristic of the image output device is reflected therein.

(18) According to the eighteenth aspect of the present invention, there is provided an apparatus for converting multi-valued image data into binary image data, where the binary image data is to be output as a visible output image by one of a plurality of image output devices. This apparatus contains: a threshold value pattern storing unit for storing a plurality of threshold value patterns each containing a plurality of elements which indicate threshold values for the plurality of pixels, and each is determined in advance so as to be specific to a respective one of the plurality of image output devices; a data inputting unit for inputting the multi-valued image data; an instruction inputting unit for inputting an instruction which indicates by which one of the plurality of image output devices the binary image data is to be output; a selection unit for selecting one of the plurality of threshold value patterns in response to the instruction; and a conversion unit for converting the multi-valued image data for the plurality of pixels into the binary image data for the plurality of pixels by respectively comparing the multi-valued image data for the plurality of pixels with the threshold values which are contained in the one of the plurality of threshold value patterns selected by the selection unit.

(19) According to the nineteenth aspect of the present invention, there is provided a computer-readable storage medium in which a program is stored, where the program, when used with a computer, directs the computer to execute a process for converting multi-valued image data into binary image data, where the binary image data is to be output as a visible output image by one of a plurality of image output devices. This process contains the steps of: (a) inputting the multi-valued image data; (b) inputting an instruction which indicates by which one of the plurality of image output devices the binary image data is to be output; (c) selecting one of a plurality of threshold value patterns in response to the instruction, where each of the plurality of threshold value patterns contains a plurality of elements which indicate threshold values for the plurality of pixels, and is determined in advance so as to be specific to a respective one of the plurality of image output devices; and (d) converting the multi-valued image data for the plurality of pixels into the binary image data for the plurality of pixels by respectively comparing the multi-valued image data for the plurality of pixels with the threshold values which are contained in the one of the plurality of threshold value patterns selected in step (c).

(20) According to the twentieth aspect of the present invention, there is provided a process for converting multi-valued image data into binary image data, where the multi-valued image data is obtained for a plurality of pixels by an image input device which detects a predetermined one of density and lightness of each pixel of an original image, and the binary image data is to be output as a visible output image by an image output device. This process contains the steps of: (a) inputting the multi-valued image data; and (b) converting the multi-valued image data for the plurality of pixels into the binary image data for the plurality of pixels by respectively comparing the multi-valued image data for the plurality of pixels with threshold values, which are determined in advance so as to be specific to a combination of the image input device and the image output device.

(20-1) In the process according to the twentieth aspect of the present invention, the threshold values may be generated in advance so that a detection characteristic for the predetermined one of density and lightness in the image input device and an output characteristic of the image output device are reflected therein.

(21) According to the twenty-first aspect of the present invention, there is provided a process for converting multi-valued image data into binary image data, where the multi-valued image data is obtained for a plurality of pixels by one of at least one image input device, the one of the at least one image input device detects a predetermined one of density and lightness of each pixel of an original image, and the binary image data is to be output as a visible output image by one of at least one image output device. This process contains the steps of: (a) inputting the multi-valued image data; (b) inputting an instruction which indicates an instruction which indicates by which one of a plurality of combinations of the at least one image input device and the at least one image output device the multi-valued image data is obtained and the binary image data is to be output, respectively; (c) selecting one of a plurality of threshold value patterns in response to the instruction, where each of the plurality of threshold value patterns contains a plurality of elements which indicate threshold values for the plurality of pixels, and is determined in advance so as to be specific to a respective one of a plurality of possible combinations of the at least one image input device and the at least one image output device; and (d) converting the multi-valued image data for the plurality of pixels into the binary image data for the plurality of pixels by respectively comparing the multi-valued image data for the plurality of pixels with threshold values which are contained in the one of the plurality of threshold value patterns selected in step (c).

(22) According to the twenty-second aspect of the present invention, there is provided an apparatus for converting multi-valued image data into binary image data, where the multi-valued image data is obtained for a plurality of pixels by an image input device which detects a predetermined one of density and lightness of each pixel of an original image, and the binary image data is to be output as a visible output image by an image output device. This apparatus contains: a data inputting unit for inputting the multi-valued image data; and a conversion unit for converting the multi-valued image data for the plurality of pixels into the binary image data for the plurality of pixels by respectively comparing the multi-valued image data for the plurality of pixels with threshold values, which are determined in advance so as to be specific to a combination of the image input device and the image output device.

(22-1) In the apparatus according to the twenty-second aspect of the present invention, the threshold values may be generated in advance so that a detection characteristic for the predetermined one of density and lightness in the image input device and an output characteristic of the image output device are reflected therein.

(23) According to the twenty-third aspect of the present invention, there is provided an apparatus for converting multi-valued image data into binary image data, where the multi-valued image data is obtained for a plurality of pixels by one of at least one image input device, the one of the at least one image input device detects a predetermined one of density and lightness of each pixel of an original image, and the binary image data is to be output as a visible output image by one of at least one image output device. This apparatus contains: a threshold value pattern storing unit for storing a plurality of threshold value patterns each containing a plurality of elements which indicate threshold values for the plurality of pixels, and each is determined in advance so as to be specific to a respective one of a plurality of possible combinations of the at least one image input device and the at least one image output device; an instruction inputting unit for inputting an instruction which indicates by which one of a plurality of combinations of the at least one image input device and the at least one image output device the multi-valued image data is obtained and the binary image data is to be output, respectively; a selection unit for selecting one of the plurality of threshold value patterns in response to the instruction; and a conversion unit for converting the multi-valued image data for the plurality of pixels into the binary image data for the plurality of pixels by respectively comparing the multi-valued image data for the plurality of pixels with the threshold values which are contained in the one of the plurality of threshold value patterns selected by the selection unit.

(24) According to the twenty-fourth aspect of the present invention, there is provided a computer-readable storage medium in which a program is stored, where the program, when used with a computer, directs the computer to execute a process for converting multi-valued image data into binary image data, where the multi-valued image data is obtained for a plurality of pixels by one of at least one image input device, the one of the at least one image input device detects a predetermined one of density and lightness of each pixel of an original image, and the binary image data is to be output as a visible output image by one of at least one image output device. This process contains the steps of: (a) inputting the multi-valued image data; (b) inputting an instruction which indicates by which one of a plurality of combinations of the at least one image input device and the at least one image output device the multi-valued image data is obtained and the binary image data is to be output, respectively; (c) selecting one of a plurality of threshold value patterns in response to the instruction, where each of the plurality of threshold value patterns contains a plurality of elements which indicate threshold values for the plurality of pixels, and is determined in advance so as to be specific to a respective one of a plurality of possible combinations of the at least one image input device and the at least one image output device; and (d) converting the multi-valued image data for the plurality of pixels into the binary image data for the plurality of pixels by respectively comparing the multi-valued image data for the plurality of pixels with threshold values which are contained in the one of the plurality of threshold value patterns selected in step (c).

(25) According to the twenty-fifth aspect of the present invention, there is provided a process for converting multi-valued image data into binary image data, where the multi-valued image data is obtained for a plurality of pixels by an image input device which detects a predetermined one of density and lightness of each pixel of an original image. This process contains the steps of: (a) inputting the multi-valued image data; (b) converting the multi-valued image data for the plurality of pixels into corrected multi-valued image data in accordance with correction data which is determined in advance so as to be specific to the image input device; and (c) converting the corrected multi-valued image data for the plurality of pixels into the binary image data for the plurality of pixels by comparing the corrected multi-valued image data for the plurality of pixels with predetermined threshold values, respectively.

(25-1) In the process according to the twenty-fifth aspect of the present invention, the correction data may be generated in advance so that a detection characteristic for the predetermined one of density and lightness in the image input device is reflected therein.

(26) According to the twenty-sixth aspect of the present invention, there is provided a process for converting multi-valued image data into binary image data, where the multi-valued image data is obtained for a plurality of pixels by one of a plurality of image input devices, and the one of the plurality of image input devices detects a predetermined one of density and lightness of each pixel of an original image. This process contains the steps of: (a) inputting the multi-valued image data; (b) inputting an instruction which indicates by which one of the plurality of image input devices the multi-valued image data is obtained; (c) selecting one of a plurality of sets of correction data in response to the instruction, where each of the plurality of sets of correction data is determined in advance so as to be specific to a respective one of the plurality of image input devices; (d) converting the multi-valued image data for the plurality of pixels into corrected multi-valued image data in accordance with the one of the plurality of sets of correction data which is selected in step (c); and (e) converting the corrected multi-valued image data for the plurality of pixels into the binary image data for the plurality of pixels by comparing the corrected multi-valued image data for the plurality of pixels with predetermined threshold values, respectively.

(27) According to the twenty-seventh aspect of the present invention, there is provided an apparatus for converting multi-valued image data into binary image data, where the multi-valued image data is obtained for a plurality of pixels by an image input device which detects a predetermined one of density and lightness of each pixel of an original image. This apparatus contains: a data inputting unit for inputting the multi-valued image data; and a correction unit for converting the multi-valued image data for the plurality of pixels into corrected multi-valued image data in accordance with correction data which is determined in advance so as to be specific to the image input device; and a conversion unit for converting the corrected multi-valued image data for the plurality of pixels into the binary image data for the plurality of pixels by comparing the corrected multi-valued image data for the plurality of pixels with predetermined threshold values, respectively.

(27-1) In the apparatus according to the twenty-seventh aspect of the present invention, the correction data may be generated in advance so that a detection characteristic for the predetermined one of density and lightness in the image input device is reflected therein.

(28) According to the twenty-eighth aspect of the present invention, there is provided an apparatus for converting multi-valued image data into binary image data, where the multi-valued image data is obtained for a plurality of pixels by one of a plurality of image input devices, and the one of the plurality of image input devices detects a predetermined one of density and lightness of each pixel of an original image. This apparatus contains: a correction data storing unit for storing a plurality of sets of correction data each set being determined in advance so as to be specific to a respective one of the plurality of image input devices; a data inputting unit for inputting the multi-valued image data; an instruction inputting unit for inputting an instruction which indicates by which one of the plurality of image input devices the multi-valued image data is obtained; a selection unit for selecting one of a plurality of sets of correction data in response to the instruction; and a correction unit for converting the multi-valued image data for the plurality of pixels into corrected multi-valued image data in accordance with the one of the plurality of sets of correction data which is selected by the selection unit; a conversion unit for converting the corrected multi-valued image data for the plurality of pixels into the binary image data for the plurality of pixels by comparing the corrected multi-valued image data for the plurality of pixels with predetermined threshold values, respectively.

(29) According to the twenty-ninth aspect of the present invention, there is provided a computer-readable storage medium in which a program is stored, where the program, when used with a computer, directs the computer to execute a process for converting multi-valued image data into binary image data, where the multi-valued image data is obtained for a plurality of pixels by an image input device which detects a predetermined one of density and lightness of each pixel of an original image. This process contains the steps of: (a) inputting the multi-valued image data; (b) inputting an instruction which indicates by which one of the plurality of image input devices the multi-valued image data is obtained; (c) selecting one of a plurality of sets of correction data in response to the instruction, where each of the plurality of sets of correction data is determined in advance so as to be specific to a respective one of the plurality of image input devices; (d) converting the multi-valued image data for the plurality of pixels into corrected multi-valued image data in accordance with the one of the plurality of sets of correction data which is selected in step (c); and (e) converting the corrected multi-valued image data for the plurality of pixels into the binary image data for the plurality of pixels by comparing the corrected multi-valued image data for the plurality of pixels with predetermined threshold values, respectively.

(30) According to the thirtieth aspect of the present invention, there is provided a process for converting multi-valued image data into binary image data, where the binary image data is to be output as a visible output image by an image output device. This process contains the steps of: (a) inputting the multi-valued image data; (b) converting the multi-valued image data for the plurality of pixels into corrected multi-valued image data in accordance with correction data which is determined in advance so as to be specific to the image output device; and (c) converting the corrected multi-valued image data for the plurality of pixels into the binary image data for the plurality of pixels by comparing the corrected multi-valued image data for the plurality of pixels with predetermined threshold values, respectively.

(30-1) In the process according to the thirtieth aspect of the present invention, the correction data may be generated in advance so that an output characteristic of the image output device is reflected therein.

(31) According to the thirty-first aspect of the present invention, there is provided a process for converting multi-valued image data into binary image data, where the binary image data is to be output as a visible output image by one of a plurality of image output devices. This process contains the steps of: (a) inputting the multi-valued image data; (b) inputting an instruction which indicates by which one of the at least one image output device the binary image data is to be output; (c) selecting one of a plurality of sets of correction data in response to the instruction, where each of the plurality of sets of correction data is determined in advance so as to be specific to a respective one of the plurality of image output devices; (d) converting the multi-valued image data for the plurality of pixels into corrected multi-valued image data in accordance with the one of the plurality of sets of correction data which is selected in step (c); and (e) converting the corrected multi-valued image data for the plurality of pixels into the binary image data for the plurality of pixels by comparing the corrected multi-valued image data for the plurality of pixels with predetermined threshold values, respectively.

(32) According to the thirty-second aspect of the present invention, there is provided an apparatus for converting multi-valued image data into binary image data, where the binary image data is to be output as a visible output image by an image output device. This apparatus contains: a data inputting unit for inputting the multi-valued image data; and a correction unit for converting the multi-valued image data for the plurality of pixels into corrected multi-valued image data in accordance with correction data which is determined a combination of the image input device and the image output device; and a conversion unit for converting the corrected multi-valued image data for the plurality of pixels into the binary image data for the plurality of pixels by comparing the corrected multi-valued image data for the plurality of pixels with predetermined threshold values, respectively.

(32-1) In the apparatus according to the thirty-second aspect of the present invention, the correction data may be generated in advance so that an output characteristic of the image output device is reflected therein.

(33) According to the thirty-third aspect of the present invention, there is provided an apparatus for converting multi-valued image data into binary image data, where the binary image data is to be output as a visible output image by one of a plurality of image output devices. This apparatus contains: a correction data storing unit for storing a plurality of sets of correction data each set being determined in advance so as to be specific to a respective one of the plurality of image output devices; a data inputting unit for inputting the multi-valued image data; an instruction inputting unit for inputting an instruction which indicates by which one of the plurality of image output devices the binary image data is output; a selection unit for selecting one of a plurality of sets of correction data in response to the instruction; and a correction unit for converting the multi-valued image data for the plurality of pixels into corrected multi-valued image data in accordance with the one of the plurality of sets of correction data which is selected by the selection unit; a conversion unit for converting the corrected multi-valued image data for the plurality of pixels into the binary image data for the plurality of pixels by comparing the corrected multi-valued image data for the plurality of pixels with predetermined threshold values, respectively.

(34) According to the thirty-fourth aspect of the present invention, there is provided a computer-readable storage medium in which a program is stored, where the program, when used with a computer, directs the computer to execute a process for converting multi-valued image data into binary image data, where the binary image data is to be output as a visible output image by an image output device. This process contains the steps of: (a) inputting the multi-valued image data; (b) inputting an instruction which indicates by which one of the at least one image output device the binary image data is to be output; (c) selecting one of a plurality of sets of correction data in response to the instruction, where each of the plurality of sets of correction data is determined in advance so as to be specific to a respective one of the plurality of image output devices; (d) converting the multi-valued image data for the plurality of pixels into corrected multi-valued image data in accordance with the one of the plurality of sets of correction data which is selected in step (c); and (e) converting the corrected multi-valued image data for the plurality of pixels into the binary image data for the plurality of pixels by comparing the corrected multi-valued image data for the plurality of pixels with predetermined threshold values, respectively.

(35) According to the thirty-fifth aspect of the present invention, there is provided a process for converting multi-valued image data into binary image data, where the multi-valued image data is obtained for a plurality of pixels by an image input device which detects a predetermined one of density and lightness of each pixel of an original image, and the binary image data is to be output as a visible output image by an image output device. This process contains the steps of: (a) inputting the multi-valued image data; (b) converting the multi-valued image data for the plurality of pixels into corrected multi-valued image data in accordance with correction data which is determined in advance so as to be specific to a combination of the image input device and the image output device; and (c) converting the corrected multi-valued image data for the plurality of pixels into the binary image data for the plurality of pixels by comparing the corrected multi-valued image data for the plurality of pixels with predetermined threshold values, respectively.

(35-1) In the process according to the thirty-fifth aspect of the present invention, wherein the correction data may be generated in advance so that a detection characteristic for the predetermined one of density and lightness in the image input device and an output characteristic of the image output device are reflected therein.

(36) According to the thirty-sixth aspect of the present invention, there is provided a process for converting multi-valued image data into binary image data, where the multi-valued image data is obtained for a plurality of pixels by one of at least one image input device, the one of the at least one image input device detects a predetermined one of density and lightness of each pixel of an original image, and the binary image data is to be output as a visible output image by one of at least one image output device. This process contains the steps of: (a) inputting the multi-valued image data; (b) inputting an instruction which indicates an instruction which indicates by which one of a plurality of combinations of the at least one image input device and the at least one image output device the multi-valued image data is obtained and the binary image data is to be output, respectively; (c) selecting one of a plurality of sets of correction data in response to the instruction, where each of the plurality of sets of correction data is determined in advance so as to be specific to a respective one of a plurality of possible combinations of the at least one image input device and the at least one image output device; (d) converting the multi-valued image data for the plurality of pixels into corrected multi-valued image data in accordance with the one of the plurality of sets of correction data which is selected in step (c); and (e) converting the corrected multi-valued image data for the plurality of pixels into the binary image data for the plurality of pixels by comparing the corrected multi-valued image data for the plurality of pixels with predetermined threshold values, respectively.

(37) According to the thirty-seventh aspect of the present invention, there is provided an apparatus for converting multi-valued image data into binary image data, where the multi-valued image data is obtained for a plurality of pixels by an image input-device which detects a predetermined one of density and lightness of each pixel of an original image, and the binary image data is to be output as a visible output image by an image output device. This apparatus contains: a data inputting unit for inputting the multi-valued image data; and a correction unit for converting the multi-valued image data for the plurality of pixels into corrected multi-valued image data in accordance with correction data which is determined a combination of the image input device and the image output device; and a conversion unit for converting the corrected multi-valued image data for the plurality of pixels into the binary image data for the plurality of pixels by comparing the corrected multi-valued image data for the plurality of pixels with predetermined threshold values, respectively.

(37-1) In the apparatus according to the thirty-seventh aspect of the present invention, the correction data may be generated in advance so that a detection characteristic for the predetermined one of density and lightness in the image input device and an output characteristic of the image output device are reflected therein.

(38) According to the thirty-eighth aspect of the present invention, there is provided an apparatus for converting multi-valued image data into binary image data, where the multi-valued image data is obtained for a plurality of pixels by one of at least one image input device, the one of the at least one image input device detects a predetermined one of density and lightness of each pixel of an original image, and the binary image data is to be output as a visible output image by one of at least one image output device. This apparatus contains: a correction data storing unit for storing a plurality of sets of correction data each set being determined in advance so as to be specific to a respective one of a plurality of possible combinations of the at least one image input device and the at least one image output device; a data inputting unit for inputting the multi-valued image data; an instruction inputting unit for inputting an instruction which indicates by which one of a plurality of combinations of the at least one image input device and the at least one image output device the multi-valued image data is obtained and the binary image data is to be output, respectively; a selection unit for selecting one of a plurality of sets of correction data in response to the instruction; and a correction unit for converting the multi-valued image data for the plurality of pixels into corrected multi-valued image data in accordance with the one of the plurality of sets of correction data which is selected by the selection unit; a conversion unit for converting the corrected multi-valued image data for the plurality of pixels into the binary image data for the plurality of pixels by comparing the corrected multi-valued image data for the plurality of pixels with predetermined threshold values, respectively.

(39) According to the thirty-ninth aspect of the present invention, there is provided a computer-readable storage medium in which a program is stored, where the program, when used with a computer, directs the computer to execute a process for converting multi-valued image data into binary image data, where the multi-valued image data is obtained for a plurality of pixels by at least one image input device which detects a predetermined one of density and lightness of each pixel of an original image, and the binary image data is to be output as a visible output image by at least one image output device. This process contains the steps of: (a) inputting the multi-valued image data; (b) inputting an instruction which indicates an instruction which indicates by which one of a plurality of combinations of the at least one image input device and the at least one image output device the multi-valued image data is obtained and the binary image data is to be output, respectively; (c) selecting one of a plurality of sets of correction data in response to the instruction, where each of the plurality of sets of correction data is determined in advance so as to be specific to a respective one of a plurality of possible combinations of the at least one image input device and the at least one image output device; (d) converting the multi-valued image data for the plurality of pixels into corrected multi-valued image data in accordance with the one of the plurality of sets of correction data which is selected in step (c); and (e) converting the corrected multi-valued image data for the plurality of pixels into the binary image data for the plurality of pixels by comparing the corrected multi-valued image data for the plurality of pixels with predetermined threshold values, respectively.

(40) According to the fortieth aspect of the present invention, there is provided a process for converting multi-valued image data into binary image data, where the multi-valued image data is obtained for a plurality of pixels by one of at least one image input device, the one of the at least one image input device detects a predetermined one of density and lightness of each pixel of an original image, and the binary image data is to be output as a visible output image by one of at least one image output device. This process contains the steps of: (a) inputting the multi-valued image data; (b) inputting an instruction containing first information which indicates by which one of the at least one image input device the multi-valued image data is obtained, and second information which indicates by which one of the at least one image output device the binary image data is to be output; (c) selecting one of at least one first set of correction data in response to the first information, and selecting one of at least one second set of correction data in response to the second information, where each of the at least one first set of correction data is determined in advance so as to be specific to a respective one of the at least one image input device, and each of the at least one first set of correction data is determined in advance so as to be specific to a respective one of the at least one image output device; (d) converting the multi-valued image data for the plurality of pixels into corrected multi-valued image data in accordance with the first and second sets of correction data which are selected in step (c); and (e) converting the corrected multi-valued image data for the plurality of pixels into the binary image data for the plurality of pixels by comparing the corrected multi-valued image data for the plurality of pixels with predetermined threshold values, respectively.

(41) According to the forty-first aspect of the present invention, there is provided an apparatus for converting multi-valued image data into binary image data, where the multi-valued image data is obtained for a plurality of pixels by one of at least one image input device, the one of the at least one image input device detects a predetermined one of density and lightness of each pixel of an original image, and the binary image data is to be output as a visible output image by one of at least one image output device. This apparatus contains: a correction data storing unit for storing at least one first set of correction data and at least one second set of correction data, where each of the at least one first set of correction data is determined in advance so as to be specific to a respective one of the at least one image input device, and each of the at least one first set of correction data is determined in advance so as to be specific to a respective one of the at least one image output device; a data inputting unit for inputting the multi-valued image data; an instruction inputting unit for inputting an instruction containing first information which indicates by which one of the at least one image input device the multi-valued image data is obtained, and second information which indicates by which one of the at least one image output device the binary image data is to be output; a selection unit for selecting one of at least one first set of correction data in response to the first information, and selecting one of at least one second set of correction data in response to the second information; and a correction unit for converting the multi-valued image data for the plurality of pixels into corrected multi-valued image data in accordance with the first and second sets of correction data which is selected by the selection unit; a conversion unit for converting the corrected multi-valued image data for the plurality of pixels into the binary image data for the plurality of pixels by comparing the corrected multi-valued image data for the plurality of pixels with predetermined threshold values, respectively.

(42) According to the forty-second aspect of the present invention, there is provided a computer-readable storage medium in which a program is stored, where the program, when used with a computer, directs the computer to execute a process for converting multi-valued image data into binary image data, where the multi-valued image data is obtained for a plurality of pixels by at least one image input device which detects a predetermined one of density and lightness of each pixel of an original image, and the binary image data is to be output as a visible output image by at least one image output device. This process contains the steps of: (a) inputting the multi-valued image data; (b) inputting an instruction containing first information which indicates by which one of the at least one image input device the multi-valued image data is obtained, and second information which indicates by which one of the at least one image output device the binary image data is to be output; (c) selecting one of at least one first set of correction data in response to the first information, and selecting one of at least one second set of correction data in response to the second information, where each of the at least one first set of correction data is determined in advance so as to be specific to a respective one of the at least one image input device, and each of the at least one first set of correction data is determined in advance so as to be specific to a respective one of the at least one image output device; (d) converting the multi-valued image data for the plurality of pixels into corrected multi-valued image data in accordance with the first and second sets of correction data which are selected in step (c); and (e) converting the corrected multi-valued image data for the plurality of pixels into the binary image data for the plurality of pixels by comparing the corrected multi-valued image data for the plurality of pixels with predetermined threshold values, respectively.

### BRIEF DESCRIPTION OF THE DRAWINGS

In the drawings:

FIG. 1 is a diagram illustrating a basic process according to the seventh aspect of the present invention;

FIG. 2 is a diagram illustrating an example of a basic pattern produced by allocating the numbers 1 to 100 to respectively predetermined elements;

FIG. 3 is a diagram illustrating an example of a conventional threshold value pattern produced from the pattern in FIG. 2;

FIG. 4 is a diagram illustrating the basic process according to the first aspect of the present invention;

FIG. 5 is a diagram illustrating an example method for obtaining the above second relationship between the theoretical and actual and density values;

FIG. 6 is a diagram illustrating an example of an input device basis correction table indicating the density detection characteristics of the image input device when the table is produced in step S1 in FIG. 5;

FIG. 7 is a diagram illustrating an example of a table indicating a relationship between the halftone dot ratios and the density values calculated from the halftone dot ratios when the table is produced in step S2-1 in FIG. 5;

FIG. 8 is a diagram illustrating an example of a table indicating a relationship between the theoretical halftone dot ratios and the actual halftone dot ratios when this relationship is obtained from the measured dot gain, and the table is produced in step S2-2 in FIG. 5;

FIG. 9 is a diagram illustrating an example of an output device basis correction table indicating the output (printing) characteristics of the image output device when the table is produced in step S2 in FIGS. 4 and 5;

FIG. 10 is a diagram illustrating an example of an input and output device basis correction table indicating a relationship between density values detected by the image input device and the theoretical values of density when the table is produced in step S3 in FIGS. 4 and 5;

FIG. 11 is a diagram illustrating an example system construction in which the data processing apparatus according to the various aspects of the present invention is used;

FIG. 12 is a diagram illustrating an example of a threshold value pattern which is produced in accordance with the present invention;

FIG. 13 is a diagram illustrating the process of producing a threshold value pattern which is corrected in response to the input and output characteristics of the image input device and the image output device, in the first embodiment of the seventh aspect of the present invention;

FIG. 14 is a diagram illustrating a standard gray chart;

FIG. 15 is an explanatory diagram illustrating the process of producing the input device basis correction table in step ST1 in FIG. 13;

FIG. 16 is a diagram illustrating an example of the table indicating the relationship between the theoretical halftone dot ratio and the density value calculated based on the theoretical halftone dot ratio when the table is produced in step ST2-1 in FIG. 13;

FIG. 17 is an explanatory diagram illustrating the process of producing a table indicating the relationship between the theoretical halftone dot ratio and the actual halftone dot ratio when the table is produced in step ST2-2 in FIG. 13;

FIG. 18 is an explanatory diagram illustrating the process of obtaining the above relationship between the theoretical and actual density values and producing the output device basis correction table;

FIG. 19 is an explanatory diagram illustrating the process of obtaining the relationship between the scanner output values and the theoretical density values, and producing the input and output device basis correction table;

FIG. 20 is an explanatory diagram illustrating the process of producing, based on the input and output device basis correction table, a conversion table which provides a value of the scanner detection level corresponding to a theoretical density value;

FIG. 21 is an explanatory diagram illustrating an example process of producing a corrected threshold value pattern based on the conversion table of FIG. 20 and the basic threshold value pattern;

FIG. 22 is a diagram illustrating the process of producing a threshold value pattern which is corrected in response to the input and-output characteristics of the image input device and the image output device, in the second embodiment of the seventh aspect of the present invention;

FIG. 23 is an explanatory diagram illustrating the process of producing the input device basis correction table in step ST1′ in FIG. 22;

FIG. 24 is a diagram illustrating an example of the table indicating the relationship between the theoretical halftone dot ratio and the lightness value calculated based on the theoretical halftone dot ratio when the table is produced in step ST2-1′ in FIG. 22;

FIG. 25 is an explanatory diagram illustrating the process of obtaining the above relationship between the theoretical and actual lightness values and producing the output device basis correction table;

FIG. 26 is an explanatory diagram illustrating the process of obtaining the relationship between the scanner output values and the theoretical lightness values, and producing the input and output device basis correction table;

FIG. 27 is an explanatory diagram illustrating the process of producing, based on the input and output device basis correction table, a conversion table which provides a value of the scanner detection level corresponding to a theoretical lightness value;

FIG. 28 is an explanatory diagram illustrating an example process of producing a corrected threshold value pattern based on the conversion table of FIG. 27 and the basic threshold value pattern;

FIG. 29 is a block diagram illustrating a construction for producing the input device basis correction table, as indicated in FIGS. 15 and 23;

FIG. 30 is a block diagram illustrating a construction for producing the output device basis correction table, as indicated in FIGS. 18 and 25;

FIG. 31 is a block diagram illustrating a construction for producing the input and output device basis correction table, as indicated in FIGS. 19 and 26;

FIG. 32 is a block diagram illustrating a construction for producing the conversion table as indicated in FIGS. 20 and 27, and converting the basic threshold value pattern lVT0 the corrected threshold value pattern;

FIG. 33 is a block diagram illustrating an example construction for correcting input image data based on the relationship between the detection output values of the image input device and the theoretical density (or lightness) values, or based on the input & output device basis correction table as indicated in FIGS. 19 and 26;

FIG. 34 is a block diagram illustrating the construction for converting multi-valued image data into binary image data, wherein the corrected threshold value pattern is stored outside the conversion unit 10;

FIG. 35 is a block diagram illustrating the basic construction for converting multi-valued image data into binary image data, wherein correction data for correcting image data is stored outside the correction unit;

FIG. 36 is a block diagram illustrating a construction for converting multi-valued image data into binary image data, wherein a plurality of corrected threshold value patterns are stored in the threshold value pattern storing unit 23 outside the conversion unit 21;

FIG. 37 is an explanatory diagram illustrating the process performed in the construction of FIG. 36 in the case wherein the corrected threshold value pattern storing unit 23 stores a plurality of threshold value patterns for two image input devices A and B, and two image output devices C and D;

FIG. 38 is a block diagram illustrating the basic construction for converting multi-valued image data into binary image data, wherein a plurality of sets of correction data for correcting image data are stored in the correction data storing unit 26 outside the correction unit 24;

FIG. 39 is an explanatory diagram illustrating the process performed in the construction of FIG. 38 in the case wherein the correction data storing unit 26 stores a plurality of threshold value patterns for two image input devices A and B, and two image output devices C and D;

FIG. 40 is a block diagram illustrating the basic construction for converting multi-valued image data into binary image data, wherein at least one set of input device basis correction data and at least one set of output device basis correction data are stored outside the correction unit; and

FIG. 41 is an explanatory diagram illustrating the process performed in the construction of FIG. 40 in the case wherein the correction data storing unit 29 stores two sets of correction data for two image input devices A and B, and the correction data storing unit 30 stores two sets of correction data for two image output devices C and D.

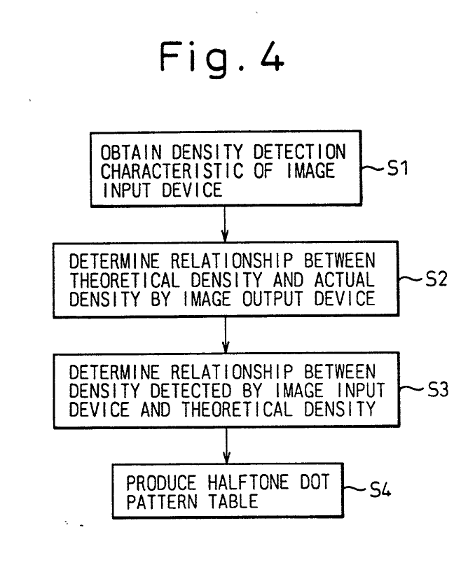

### DESCRIPTION OF THE PREFERRED EMBODIMENTS OUTLINE OF CORRECTION OF THRESHOLD VALUE PATTERN (FIGS. 4 TO 10)

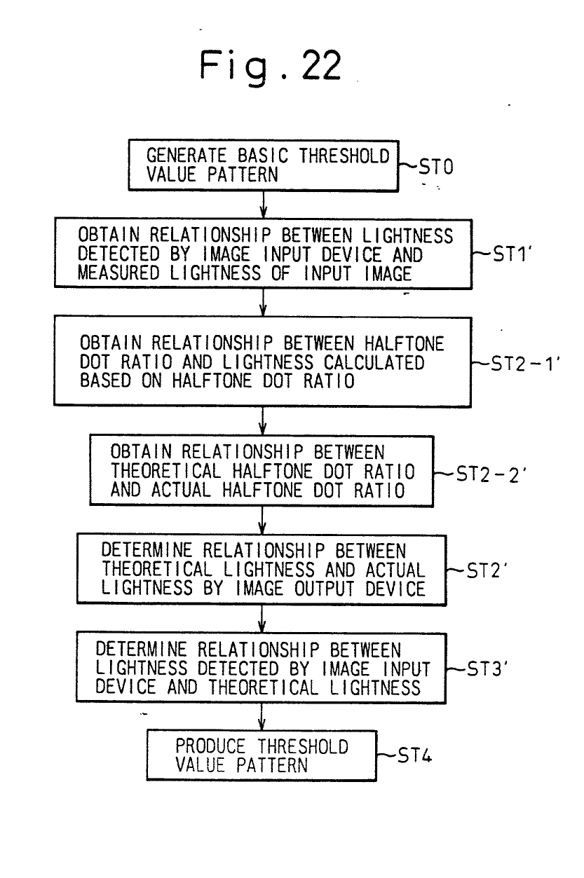

Although the descriptions in FIGS. 4 to 10 are provided for the case using density, the density may be replaced with lightness, as explained later with reference to FIGS. 22 to 28.

FIG. 4 is a diagram illustrating an outline of an embodiment of the process according to the seventh aspect of the present invention. This process is provided for producing a threshold value pattern which is used for converting multi-valued image data into binary image data, where the multi-valued image data is obtained for a plurality of pixels by an image input device which detects a predetermined one of density and lightness of each pixel of an original image, and the binary image data is to be output as a visible output image by an image output device.

In the processes according to the first, fourth, and seventh aspect of present invention, the threshold value pattern is obtained by correcting a basic threshold value pattern. The basic threshold value pattern contains a plurality of elements which indicate threshold values for the plurality of pixels. The threshold values in the basic threshold value pattern are determined in the conventional techniques in the dither method, the dot pattern method, and the like. For example, in the dither method, one threshold value (one pixel of the threshold value pattern) is provided corresponding to each pixel in the input image, and in the other methods such as the dot pattern method, a plurality of threshold values (a plurality of pixels of the threshold value pattern) are provided corresponding to each pixel in the input image.

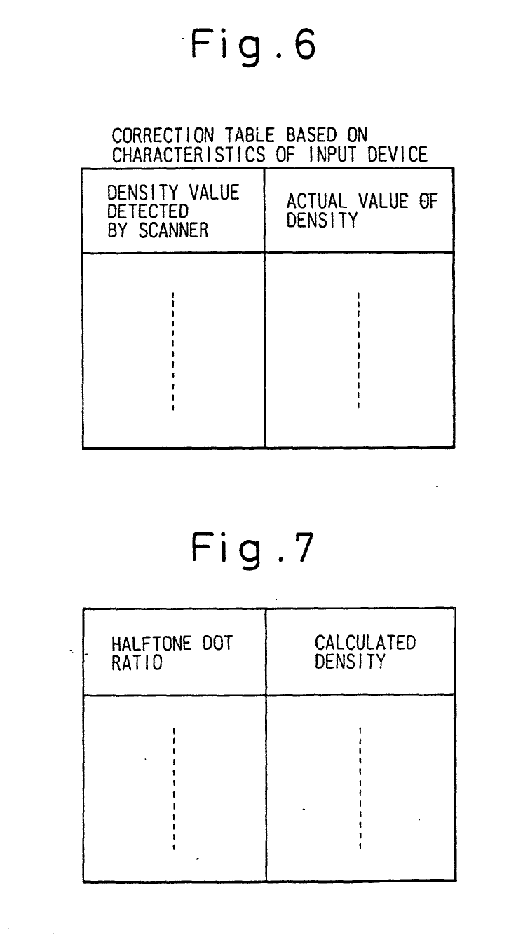

In step S1, the first information which indicates a detection characteristic for the predetermined one of density and lightness in the image input device, is obtained. In this example, a first relationship between density values which are detected by the image input device, and density values which are measured by another density measurement device with high accuracy, is obtained as the detection characteristic of the image input device. Based on this first relationship, a table as indicated in FIG. 6, can be produced.

In step S2, the second information which indicates an output characteristic of the image output device, is obtained. In this embodiment, as the output characteristic, a second relationship between theoretical density values and actual density values by the image output device is obtained, where the theoretical density values are theoretical target values of density which the image output device is instructed to output, and the actual values of density are actual values of density in an actual output image produced by the image output device when the image output device is instructed to output with the theoretical values of density. The difference between the theoretical and actual values of density is caused by, for example, a dot gain. The dot gain is a difference between a theoretical dot size, i.e., the size of a dot which the image output device is instructed to output on an output image, and an actual dot size, i.e., the size of a dot which the image output device actually output on the output image when the image output device is instructed to output a dot with the theoretical dot size.

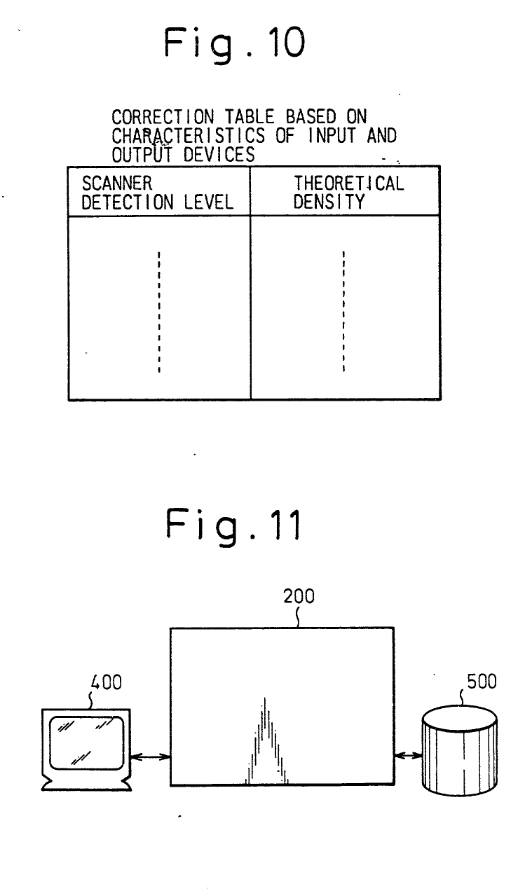

In step S3, a third relationship between the values of density which are detected by the image input device and the theoretical values of density, is obtained based on the above first and second relationships. In actual practice, values of the multi-valued image-data are values of density which are detected from an original image by the image input device such as an image scanner, while, conventionally, data processing for the conversion from the multi-valued image data to the binary image data has been performed based on the theoretical values of density. Since the threshold values are used for comparison with the values of the multi-valued image data, it is desirable to convert the threshold values represented as theoretical values, to corrected threshold values which are represented on the same basis as the values of the multi-valued image data detected by the image input device. Thus, the above third relationship between the detected values and the theoretical values of density is obtained for this purpose. The above third relationship provides theoretical values which are to be instructed to the image output device for making the image output device realize the output image with actually the same density as the original image, in response to the input of the values of density detected by the image input device. Based on this third relationship, a table as indicated in FIG. 10, can be produced.

Therefore, in step S4, the threshold values in the basic (conventional) threshold value pattern, which are represented as theoretical values, are corrected (converted into corrected threshold values) to the corrected threshold values, which are represented on the same basis as the values of the multi-valued image data detected by the image input device. Thus, a halftone dot pattern (threshold value pattern) containing the corrected threshold values is obtained. Since the detection characteristic of the image input device and the output characteristic of the image output device are reflected in the corrected threshold values, deterioration of an output image due to the detection characteristics of the image input device and the output characteristics of the image output device can be easily avoided.

In the applications wherein the output characteristics of the image output device need not be considered, for example, in the case wherein the output characteristic of the image output device is ignorable, steps S2 and S3 may be eliminated. In this case, the process of FIG. 4 realizes the process of the first aspect of the present invention.

In the applications wherein the input characteristics of the image input device need not be considered, for example, in the case the multi-valued image data is produced by digital image processing, steps S1 and S3 may be eliminated. In this case, the process of FIG. 4 realizes the process of the fourth aspect of the present invention.

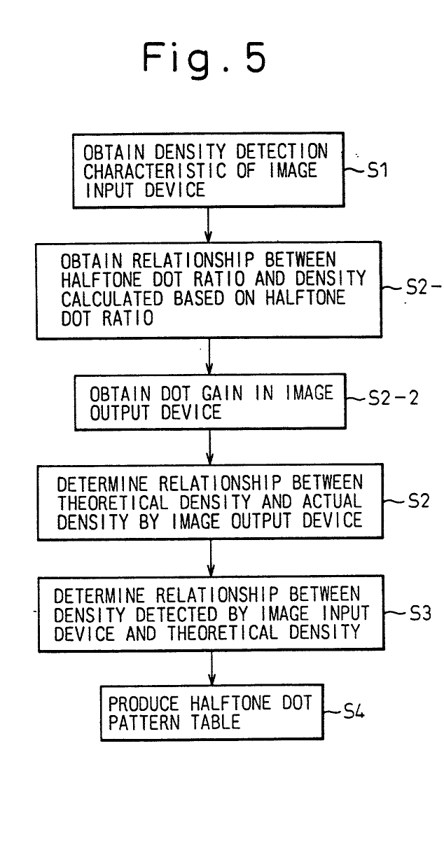

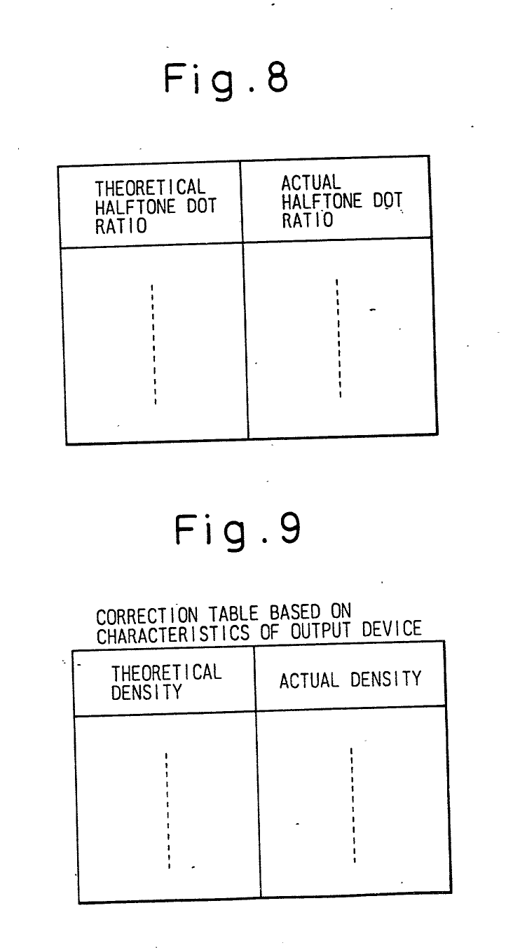

FIG. 5 shows an example method for obtaining the above second relationship between the theoretical and actual and density values. For this purpose, in the process of FIG. 5, the sub-steps S2-1 and S2-2 are inserted before step S2. In step S2-1, a relationship between halftone dot ratios and density values is obtained as a fourth relationship, where the density values can be calculated from the value of the halftone dot ratio based on a predetermined equation. The halftone dot ratio is defined as a ratio of the number of black pixels generated by the conversion by using the threshold value pattern, to the total number of pixels generated by the conversion by using the threshold value pattern when multi-valued image data corresponding to the total number of pixels and having the same density are converted to binary image data by using the threshold value pattern. Therefore halftone dot ratio varies with the density of the input image. Based on this fourth relationship, a table as indicated in FIG. 7, can be produced. Then, in step S2-2, the dot gain in the image output device is obtained. The dot gain indicates an increase in an area of a dot which is the actually output on the output image, compared with an area of a dot which-is to be output theoretically. Based on this increase in the dot area, actual halftone dot ratios are calculated from the theoretical halftone dot ratios. Thus, a fifth relationship between the actual halftone dot ratios and the theoretical halftone dot ratios is obtained. Based on this fifth relationship, a table as indicated in FIG. 8, can be produced. Then, in step S2, theoretical values of density can be obtained from the respective theoretical halftone dot ratio values and the above fourth relationship between the halftone dot ratio values and the density values, and actual values of density can be obtained from the respective actual halftone dot ratio values and the above fourth relationship between the halftone dot ratio values and the density values. Therefore, based on the above fourth and fifth relationships, a sixth relationship between theoretical values and actual values of density is obtained. Based on this sixth relationship, a table as indicated in FIG. 9, can be produced.

### OUTLINE OF SYSTEM CONSTRUCTION (FIG. 11)

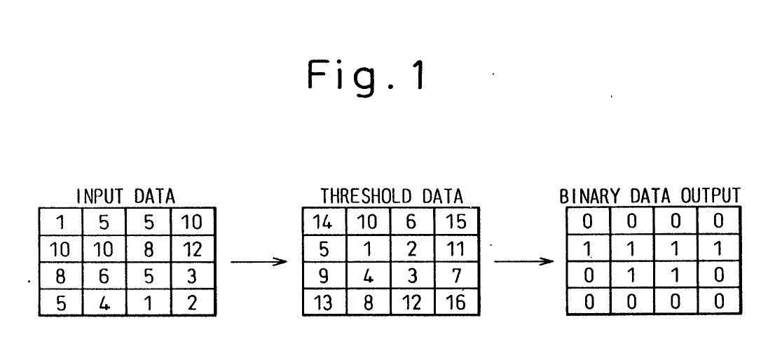

FIG. 11 is a diagram illustrating an example system construction in which the data processing apparatus according to the various aspects of the present invention is used. In FIG. 1, reference numeral 400 denotes a terminal provided for an interactive operation with a user, 200 denotes a data processing apparatus, and 500 denotes an disc device in which the multi-valued image data, the binary image data, the threshold value pattern(s), data on the detection characteristics of image input devices, and data on the output characteristics of image output devices, and the correction data including various tables as explained later, may be stored. Any of the above data stored in the disc device 500 may be supplied from the terminal 400. The data processing apparatus may be constructed by hardware logic circuitry, a programed computer, or any combination thereof. The correction of the threshold value pattern and the conversion from the multi-valued image data into the binary image data according to the various aspects of the present invention are performed in the data processing apparatus 200. That is, the processes according to various aspects of the present invention can be performed by the data processing apparatus 200. The control of execution of these processes may be instructed by a program. Such a program may be stored in any of storage medium such as a floppy disc, a CD-ROM, and may be installed in the above system. A portion or all of the program for instructing the execution of the process according to any of the various aspects of the present invention may be implemented in the form of hardware circuitry. Although not shown, the image input device(s) and the image output device(s) may be directly connected to the data processing apparatus 200.

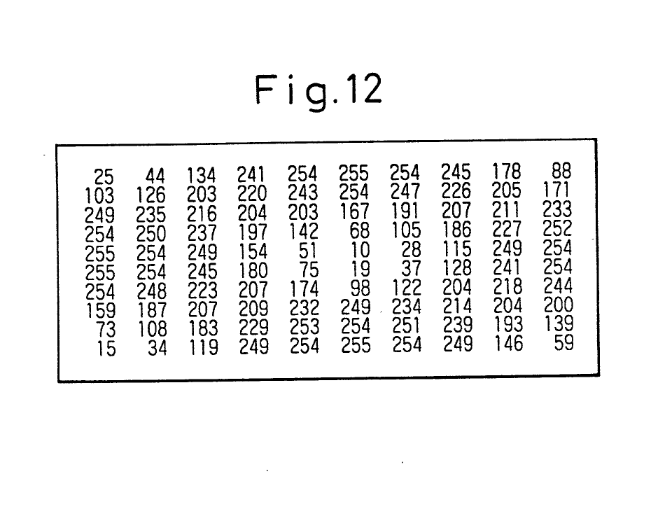

### EXAMPLE OF CORRECTED THRESHOLD VALUE PATTERN (FIG. 12)

FIG. 12 is a diagram illustrating an example of a threshold value pattern which is produced in accordance with the present invention. The threshold value pattern of FIG. 12 is for use in conversion of 256-valued data into a binary image data, and contains 10×10 elements (threshold values). In the example of FIG. 12, the threshold values are greatly shifted from those in the conventional threshold value pattern of FIG. 3.

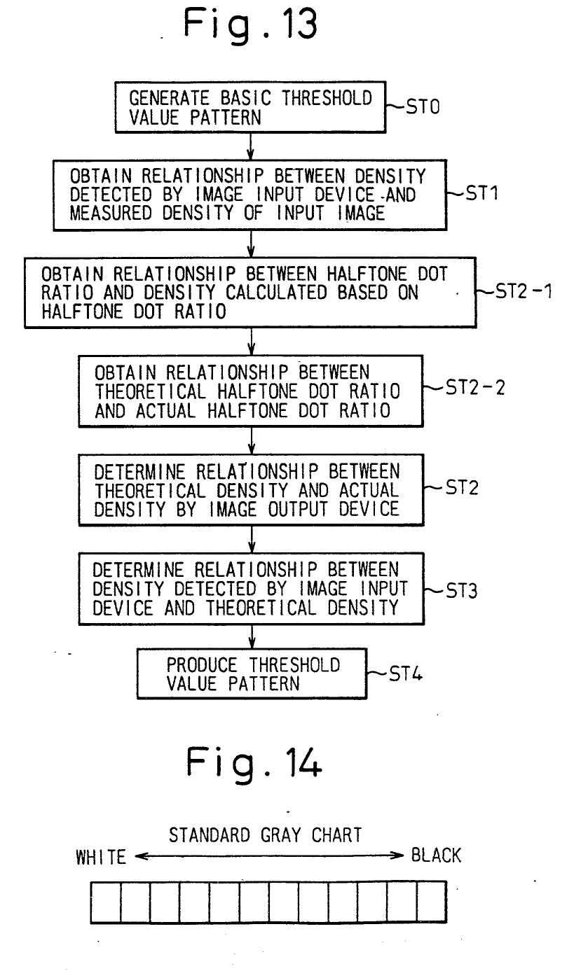

### PROCESS FOR CORRECTION OF THRESHOLD VALUE PATTERN ON DENSITY BASIS (FIGS. 13 TO 21)

FIG. 13 is a diagram illustrating the process of producing a threshold value pattern which is corrected in response to the input and output characteristics of the image input device and the image output device, in the first embodiment of the seventh aspect of the present invention. The process of FIG. 13 in the first embodiment is basically the same as the process of FIG. 5, and therefore, only additional details are explained below.

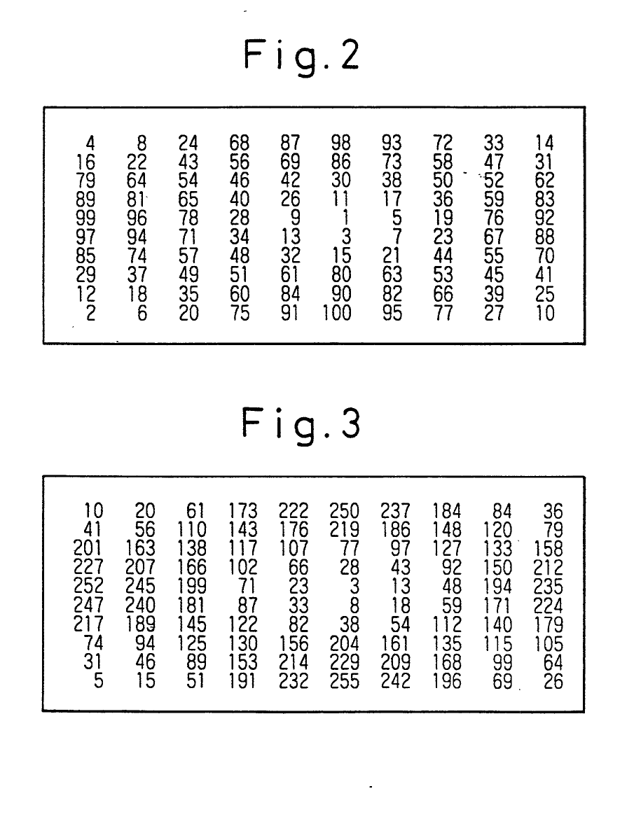

In step ST0 of FIG. 13, the basic threshold value pattern is generated. The basic threshold value pattern may be generated as explained before with reference to FIGS. 2 and 3.

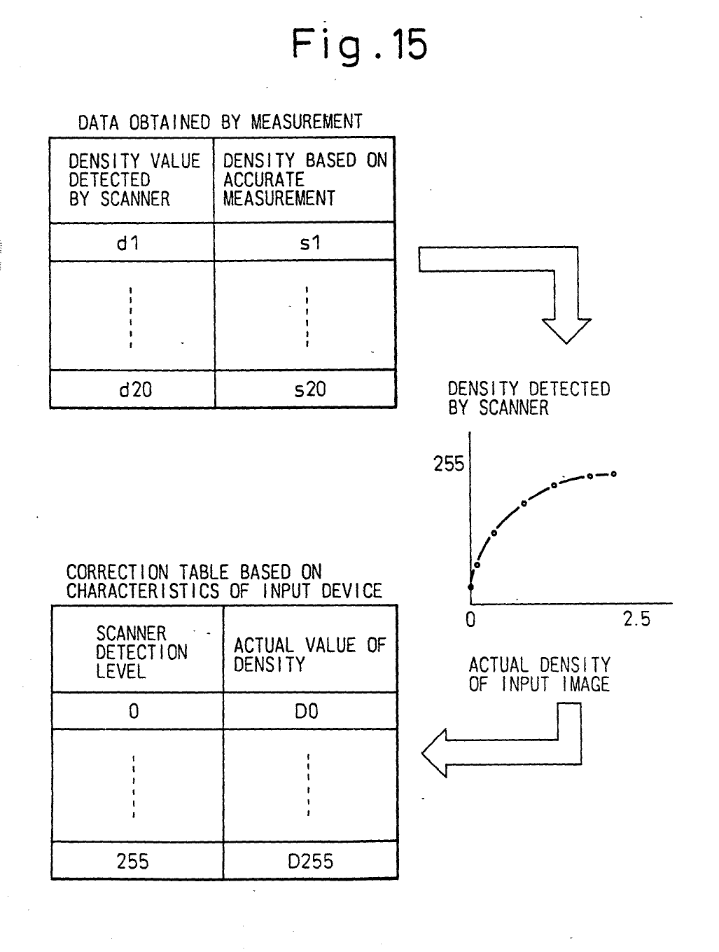

Next, for preparing the data on the detection characteristic of the image input device, a standard gray chart as indicated in FIG. 14 may be used. The standard gray chart contains a plurality of areas, and the densities of the respective areas increase in steps from white to black. The density of each area of the gray chart is scanned by the image input device (such as an image scanner), and is measured by another density measurement device with high accuracy, and the results of the measurement by the image input device and the density measurement device are input into the data processing apparatus 200 through the terminal 400, as indicated in the upper left portion of FIG. 15. The data processing apparatus 200 receives the results, interpolates the results, and generates an input device basis correction table as indicated in the lower left portion of FIG. 15. This is the operation of step ST1, and the input device basis correction table of FIG. 15 corresponds to the table of FIG. 6.

In step ST2-1 of FIG. 13, the relationship between the halftone dot ratios and the density values is obtained as follows.

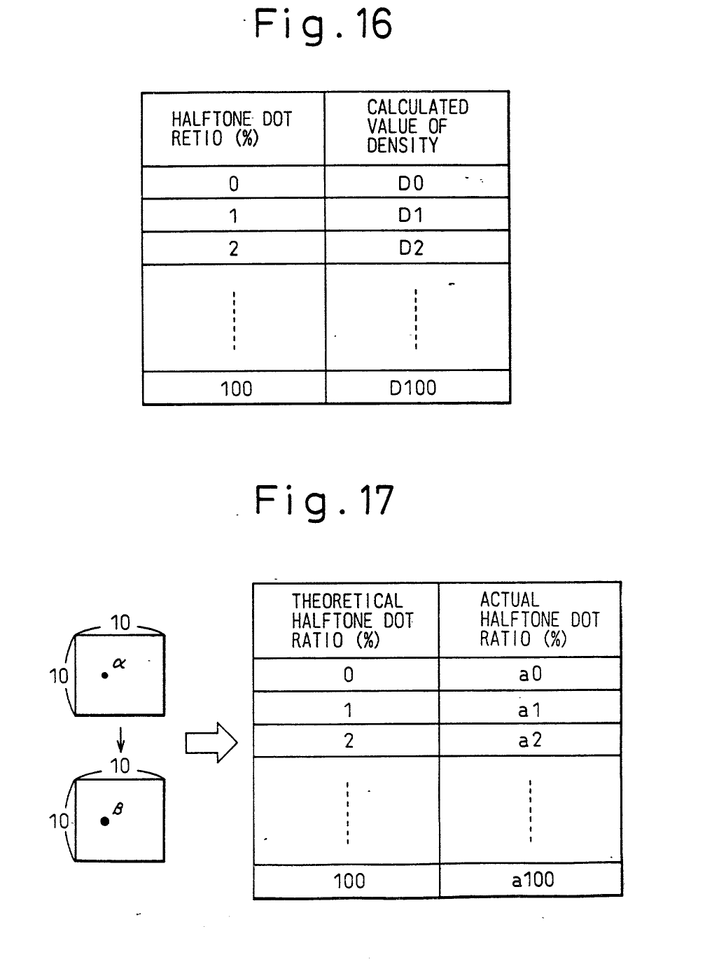

For the operation in step ST2-1, it is necessary to obtain the accurate density values of a background area of the output image and a black (dotted) area. The background area may be paper for printing, and the black area may be an area dotted with ink which is to be used in the printing by a printer as the image output device. The density values may be measured by the above-mentioned density measurement device with high accuracy, and the results of the measurement are input into the data processing apparatus 200 through the terminal 400. The data processing apparatus 200 receives the density value D_{W} of the background area and the density value D_{B} of the dotted area, and calculates the reflectance R_{N} of the background area and the reflectance R_{B} of the dotted area by using the equation, R=10^{-D}. Then, the reflectance values for respective values of the halftone dot ratio (%) is obtained by substituting the above reflectance values R_{W} and R_{B} into the equation, R=a×R_{B}+(1−a)R_{W}, and the reflectance values are substituted into the equation, R=10^{-D} to obtain the corresponding density values. Thus, the relationship between the values of the halftone dot ratio (%) and the density values is obtained, and a table as indicated in FIG. 16 can be produced.

In step ST2-2 of FIG. 13, the relationship between the theoretical halftone dot ratios and the actual halftone dot ratios is obtained as follows.

For the operation in step ST2-2, it is necessary to obtain the dot gain. Generally, image output devices such as printing machines tends to print a dot which is greater in size than the theoretically expected dot size, as indicated in the left portion of FIG. 17. The dot gain is obtained, for example, by measuring an actual diameter of a printed dot with a microscope. In the case wherein a rotary press is used as the image output device, the dot gain may be measured on a block copy. The obtained diameter and the theoretical diameter are input into the data processing apparatus 200 through the terminal 400. The data processing apparatus 200 receives these data, and calculates the increase in the area of the actually printed dot compared to the area of the theoretical dot, and the increase in the halftone dot ratio for the respective values of the theoretical halftone dot ratio to obtain the corresponding actual values of the halftone dot ratio. Thus, the relationship between the theoretical and actual values of the halftone dot ratio (%) is obtained, and a table, as indicated in FIG. 17, can be produced.

In step ST2 of FIG. 13, the relationship between the theoretical and actual density values is obtained as follows based on the above relationship between the halftone dot ratios and the density values, which is obtained in step ST2-1, and the above relationship between the theoretical and actual halftone dot ratios, which is obtained in step ST2-2.

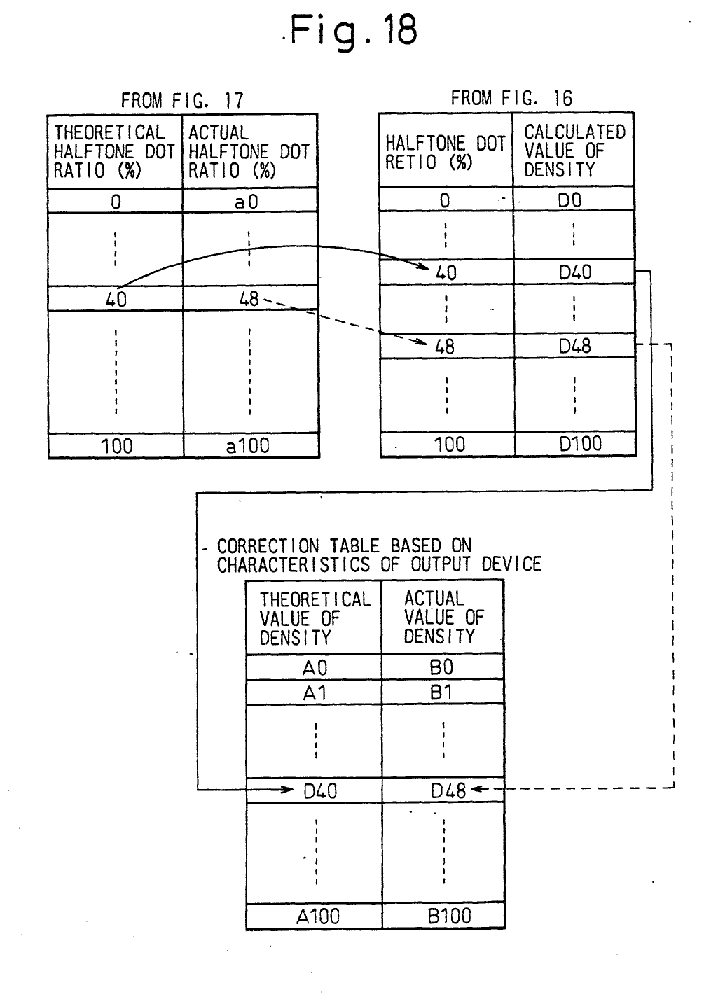

FIG. 18 is an explanatory diagram illustrating the process of obtaining the above relationship between the theoretical and actual density values and producing the output device basis correction table. As indicated in FIG. 18, and as explained before with reference to FIG. 5, by using the relationship between the halftone dot ratios and the density values (the table of FIG. 16), density values corresponding to the respective values of the theoretical halftone dot ratio and density values corresponding to the respective values of the actual halftone dot ratio are obtained, respectively, as the theoretical density values and the actual density values. Thus, the output device basis correction table as indicated in FIG. 18 is obtained. In the obtained relationship between the theoretical and actual density values, the printing characteristics of the image output device is reflected, and this relationship teaches what theoretical density value the data processing apparatus should instruct to the image output device for actually realizing a desired density in the output image by the image output device.

In step ST3 of FIG. 13, the relationship between the scanner output values and the theoretical density values is obtained as follows based on the above relationship between the scanner output values and the actual density values (the input device basis correction table of FIG. 15), which is obtained in step ST1, and the above relationship between the theoretical and actual density values (the output device basis correction table of FIG. 18), which is obtained in step ST2.

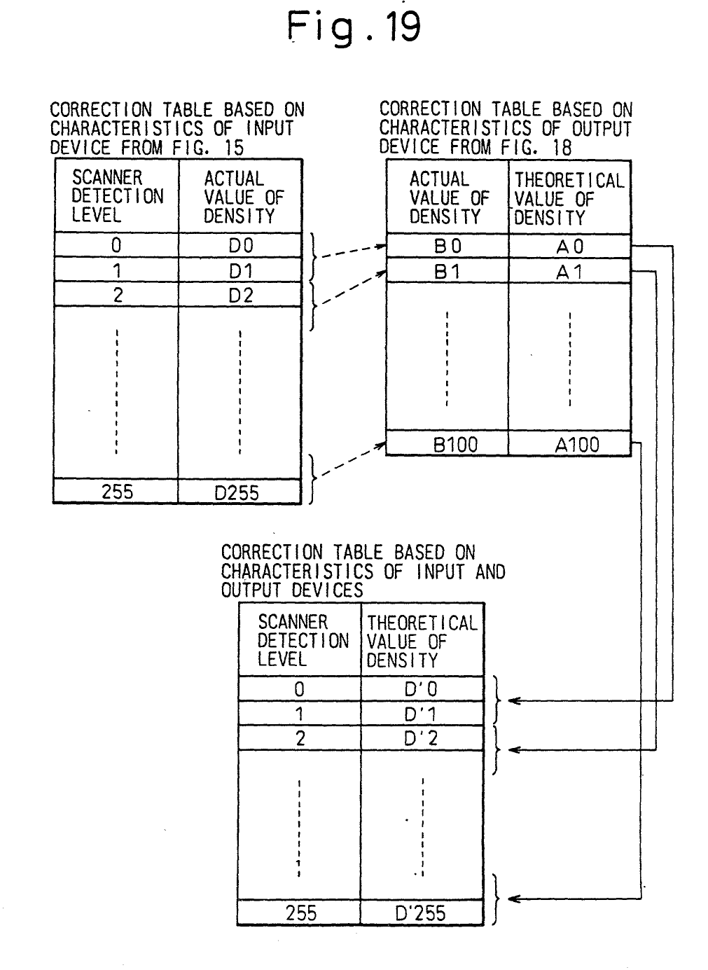

FIG. 19 is an explanatory diagram illustrating the process of obtaining the relationship between the scanner output values and the theoretical density values, and producing the input and output device basis correction table. As indicated in FIG. 19, first, the actual density values are obtained for the respective values of the scanner output values in the input device basis correction table of FIG. 15, and then the theoretical density values are obtained for the obtained actual density values by using the output device basis correction table of FIG. 18. Although the actual density values in the input device basis correction table of FIG. 15 are provided for 256 values, and the actual density values in the output device basis correction table of FIG. 18 are provided for 100 values, for example, the nearest actual value may be searched in the output device basis correction table of FIG. 16, or interpolation may be used for obtaining the theoretical density values by using the output device basis correction table of FIG. 16. Thus, theoretical density values can be obtained for the respective values of the scanner output, as an input and output device basis correction table, as indicated in the lower portion of FIG. 19. The detection characteristic of the image input device and the output (printing) characteristics of the image output device are reflected in the obtained relationship between the scanner output values and the theoretical density values, and this relationship teaches what theoretical density value the data processing apparatus should instruct to the image output device for actually reproducing a desired density corresponding to a scanner output value in the output image by the image output device.

In step ST4 of FIG. 13, the threshold value pattern containing corrected threshold values is produced as follows.

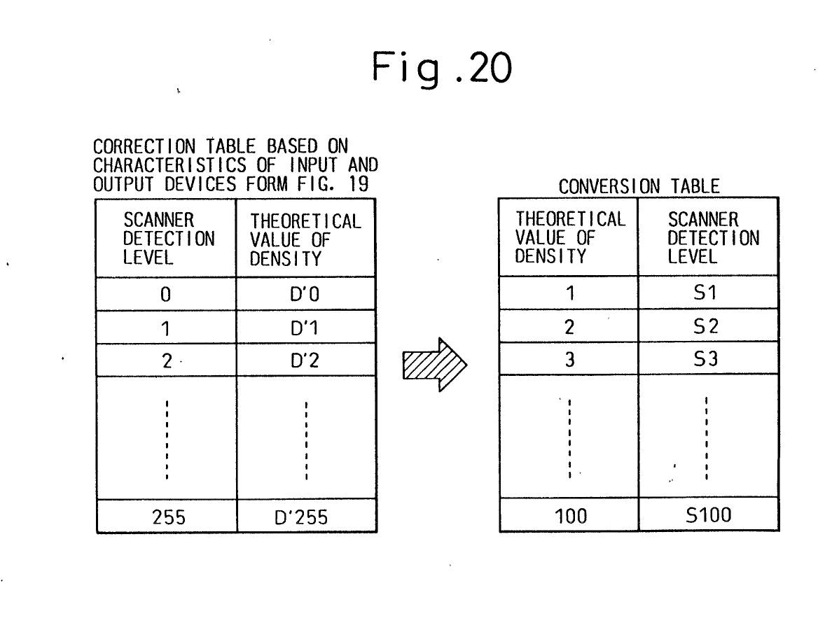

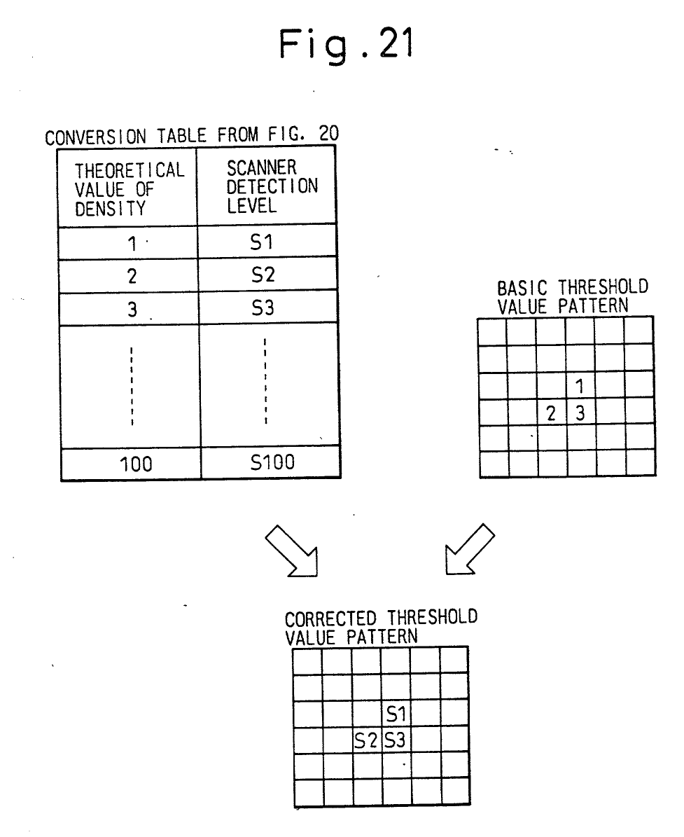

As explained before with reference to FIG. 5, the threshold values in the basic threshold value pattern should be converted to the corrected threshold values which are represented on the same basis as the scanner output values. Namely, the threshold values in the basic threshold value pattern should be converted into the scanner output values in accordance with the above relationship between the scanner output values and the theoretical density values, which relationship reflects therein the detection characteristic of the image input device and the output (printing) characteristics of the image output device. Therefore, in this embodiment, a conversion table from the theoretical density values to the scanner output values is generated from the above input and output device basis correction table of FIG. 19, as indicated in FIG. 20. In the example of FIG. 20, it is assumed that the threshold values in the threshold value pattern are provided for 100 values. Since the values in the input and output device basis correction table of FIG. 19 are provided for 256 values, for example, interpolation may be used for obtaining the values in the conversion table of FIG. 20. By using the conversion table of FIG. 20, the threshold values in the basic threshold value pattern are converted into the values represented on the same basis as the scanner output values, as indicated in FIG. 21.

### PROCESS FOR CORRECTION OF THRESHOLD VALUE PATTERN ON LIGHTNESS BASIS (FIGS. 22 TO 28)

FIG. 22 is a diagram illustrating the process of producing a threshold value pattern which is corrected in response to the input and output characteristics of the image input device and the image output device, in the second embodiment of the seventh aspect of the present invention. The process of FIG. 22 in the second embodiment is basically the same as the processes of FIG. 5 and FIG. 13, and only the difference from the process of FIG. 13 is that lightness, instead of the density, is used in the second embodiment. Therefore, only additional details are explained below.

In step ST0 of FIG. 22, the basic threshold value pattern is generated. The basic threshold value pattern may be generated as explained before with reference to FIGS. 2 and 3.

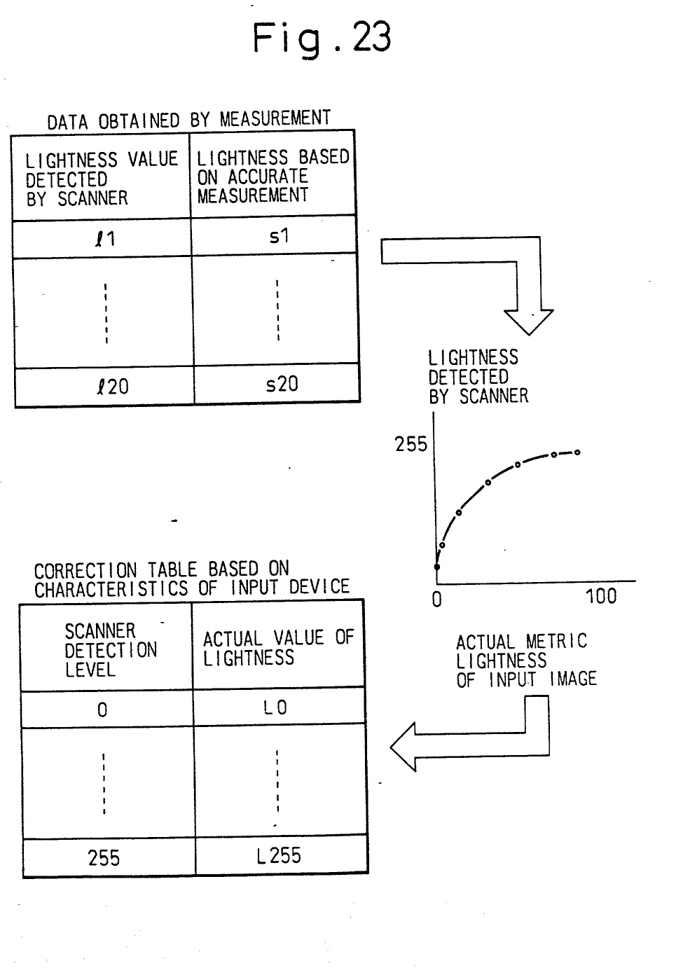

Next, for preparing the data on the detection characteristic of the image input device, a standard gray chart, as explained before with reference to FIG. 14, may be used. In this embodiment, the lightness, instead of density, of each area of the gray chart is scanned by the image input device (such as an image scanner), and is measured by another lightness measurement device with high accuracy, and the results of the measurement by the image input device and the lightness measurement device are input into the data processing apparatus 200 through the terminal 400, as indicated in the upper left portion of FIG. 15. The data processing apparatus 200 receives the results, interpolates the results, and generates an input device basis correction table as indicated in the lower left portion of FIG. 23. This is the operation of step ST1′, and the input device basis correction table of FIG. 23 corresponds to the table of FIG. 6.

In step ST2-1′ of FIG. 22, the relationship between the halftone dot ratios and metric lightness values is obtained as follows.

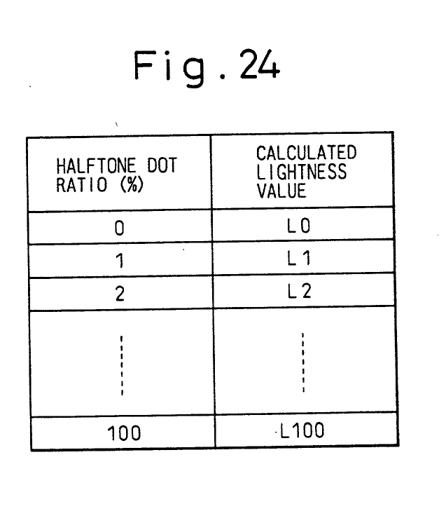

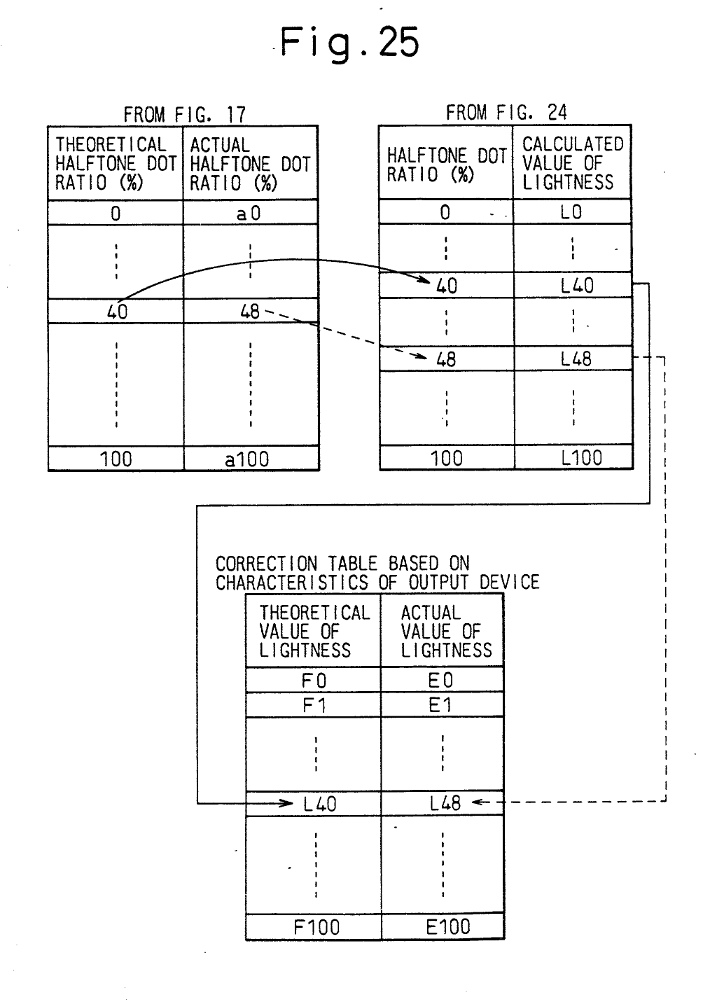

For the operation in step ST2-1′, it is also necessary to obtain the reflectance value R from the accurate density value D_{W} of a background area of the output image and the accurate density value D_{B} of the black (dotted) area, in accordance with the same equations as those used in the first embodiment. Then, the metric lightness values L for the respective values of the reflectance values R, are obtained by the equation, L=116×(R/R_{W})^{⅓}−16, where the reflectance values R are obtained by the equation, R=a×R_{B}+(1−a)R_{W}. Thus, the relationship between the values of the halftone dot ratio (%) and the lightness values is obtained, and a table as indicated in FIG. 24 can be produced.

In step ST2-2′ of FIG. 22, the relationship between the theoretical halftone dot ratios and the actual halftone dot ratios is obtained as explained for step ST2-2 of FIG. 13.

In step ST2′ of FIG. 22, the relationship between the theoretical and actual lightness values is obtained based on the above relationship between the halftone dot ratios and the lightness values, which is obtained in step ST2-1′, and the above relationship between the theoretical and actual halftone dot ratios, which is obtained in step ST2-2′. FIG. 25 is an explanatory diagram illustrating the process of obtaining the above relationship between the theoretical and actual lightness values and producing the output device basis correction table. As understood from FIG. 25, the relationship between the theoretical and actual lightness values is obtained in the same manner as that is explained for the relationship between the theoretical and actual density values with reference to FIG. 18.

In step ST3′ of FIG. 22, the relationship between the scanner output values and the theoretical lightness values is obtained based on the above relationship between the scanner output values and the actual lightness values (the input device basis correction table of FIG. 23), which is obtained in step ST1′, and the above relationship between the theoretical and actual lightness values (the output device basis correction table of FIG. 25), which is obtained in step ST2′.

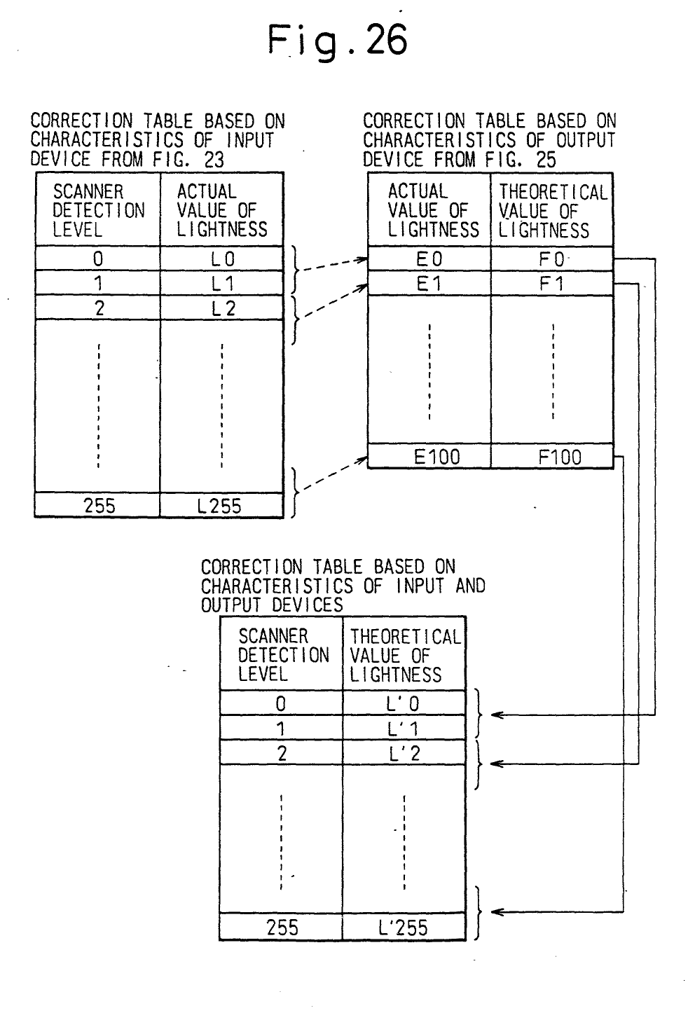

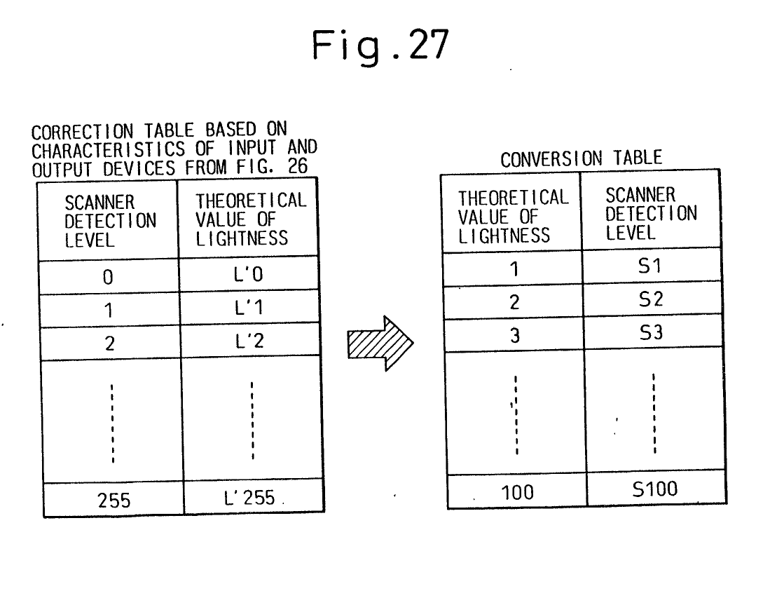

FIG. 26 is an explanatory diagram illustrating the process of obtaining the relationship between the scanner output values and the theoretical lightness values, and producing the input and output device basis correction table. As understood from FIG. 26, the relationship between the scanner output values and the theoretical lightness values is obtained in the same manner as that is explained for the relationship between the scanner output values and the theoretical density values with reference to FIG. 19.

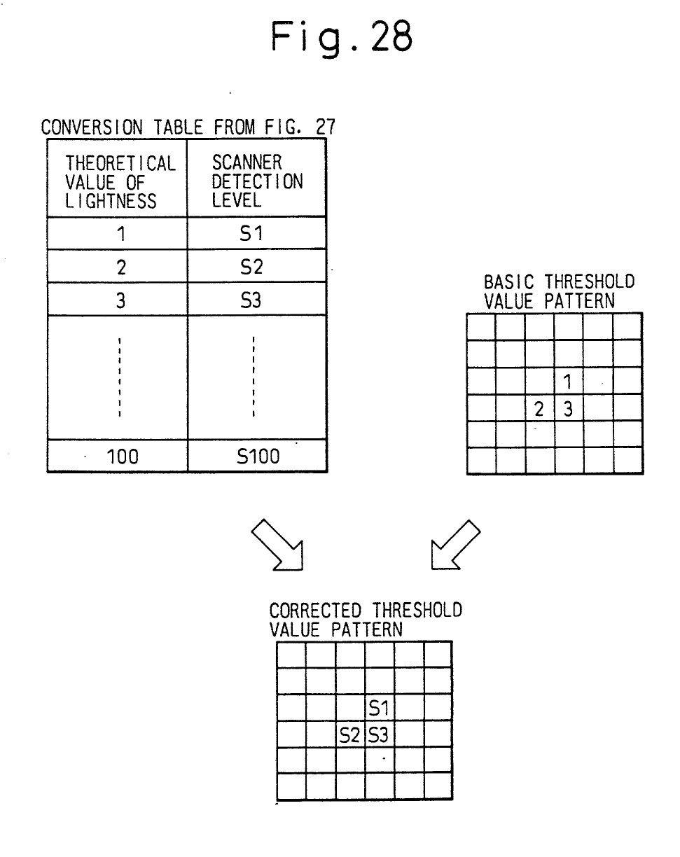

In step ST4′ of FIG. 22, the threshold value pattern containing corrected threshold values is produced in the same manner as in step ST4 in FIG. 13. Namely, in this embodiment, a conversion table from the theoretical lightness values to the scanner output values is generated from the above input and output device basis correction table of FIG. 26, as indicated in FIG. 27. In the example of FIG. 27, it is also assumed that the threshold values in the threshold value pattern are provided for 100 values. Since the values in the input and output device basis correction table of FIG. 26 are provided for 256 values, for example, interpolation may be used for obtaining the values in the conversion table of FIG. 27. By using the conversion table of FIG. 27, the threshold values in the basic threshold value pattern are converted into the values represented on the same basis as the scanner output values, as indicated in FIG. 28.

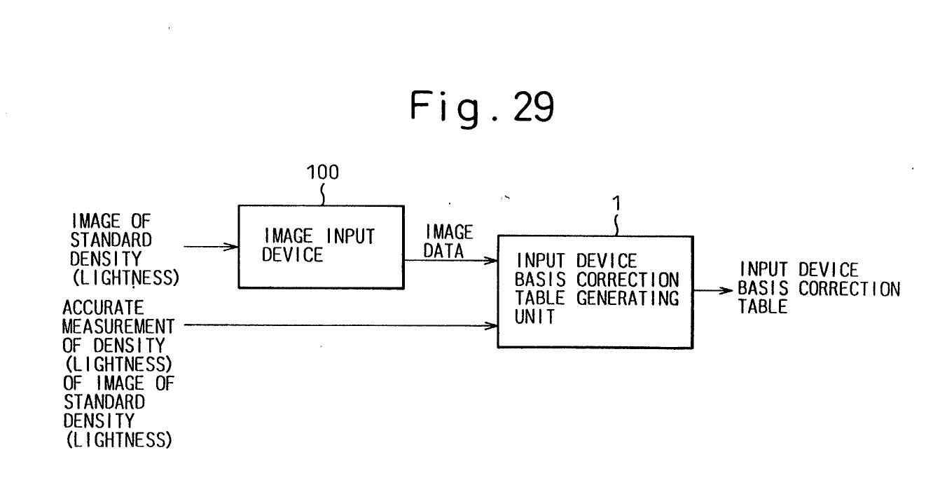

### CONSTRUCTION OF GENERATING INPUT DEVICE BASIS CORRECTION TABLE (FIG. 29)

FIG. 29 is a block diagram illustrating a construction for producing the input device basis correction table, as indicated in FIGS. 15 and 23. As indicated in FIG. 29, the input device basis correction table generation unit 1 receives the density (or lightness) data obtained by the measurement of the sample image such as each of areas of the standard gray chart by the density (or lightness) measurement device, and the output of the image input device 100 which scans the same sample image and outputs multi-valued image data indicating the density value which the image input device detects from the sample image. The input device basis correction table generation unit 1 may be realized with hardware circuitry, a programed computer, or any combination of them, and in the system construction of FIG. 11, the data processing apparatus 200 can realize the function of this unit 1.

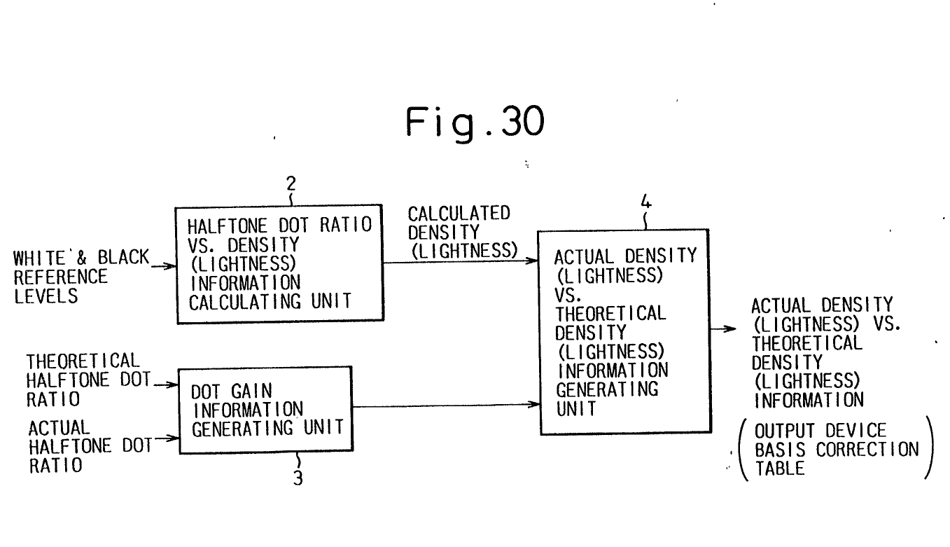

### CONSTRUCTION OF GENERATING OUTPUT DEVICE BASIS CORRECTION TABLE (FIG. 30))

FIG. 30 is a block diagram illustrating a construction for producing the output device basis correction table, as indicated in FIGS. 18 and 25. In the construction of FIG. 30, the halftone dot ratio vs. density (lightness) information calculation unit 2 performs the operation in step ST2-1 in FIG. 13 or step ST2-1¹ in FIG. 22, the dot gain information generation unit 3 performs the operation in step ST2-2 in FIG. 13 or step ST2-2′ in FIG. 22, and the actual density (lightness) vs. theoretical density (lightness) information generation unit 4 performs the operation in step ST2 in FIG. 13 or step ST2′ in FIG. 22. Each of these units 2, 3, and 4 may be realized with hardware circuitry, a programed computer, or any combination of them, and in the system construction of FIG. 11, the data processing apparatus 200 can realize the functions of these units 2, 3, and 4.

### CONSTRUCTION OF GENERATING INPUT & OUTPUT DEVICE BASIS CORRECTION TABLE (FIG. 1)

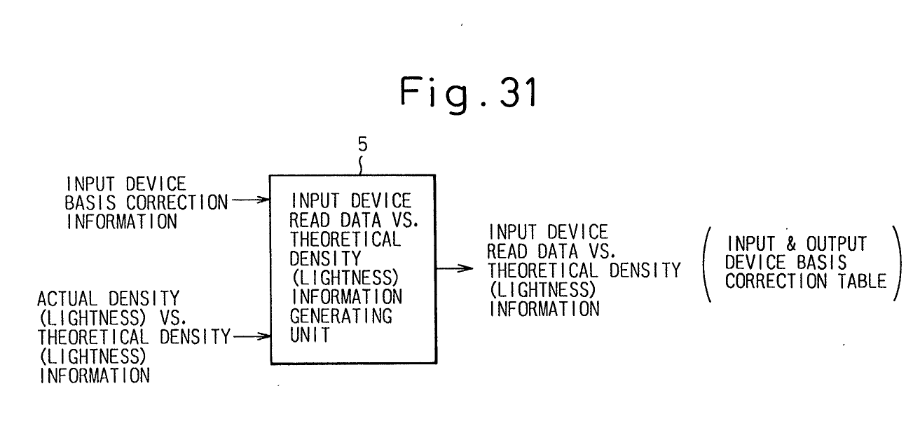

FIG. 31 is a block diagram illustrating a construction for producing the input and output device basis correction table, as indicated in FIGS. 19 and 26. The input device read data vs. density information generation unit 5 in the construction of FIG. 31 performs the operation explained with reference to FIGS. 19 and 26. The input device read data vs. density information generation unit 5 may be realized with hardware circuitry, a programed computer, or any combination of them, and in the system construction of FIG. 11, the data processing apparatus 200 can realize the function of this unit 5.

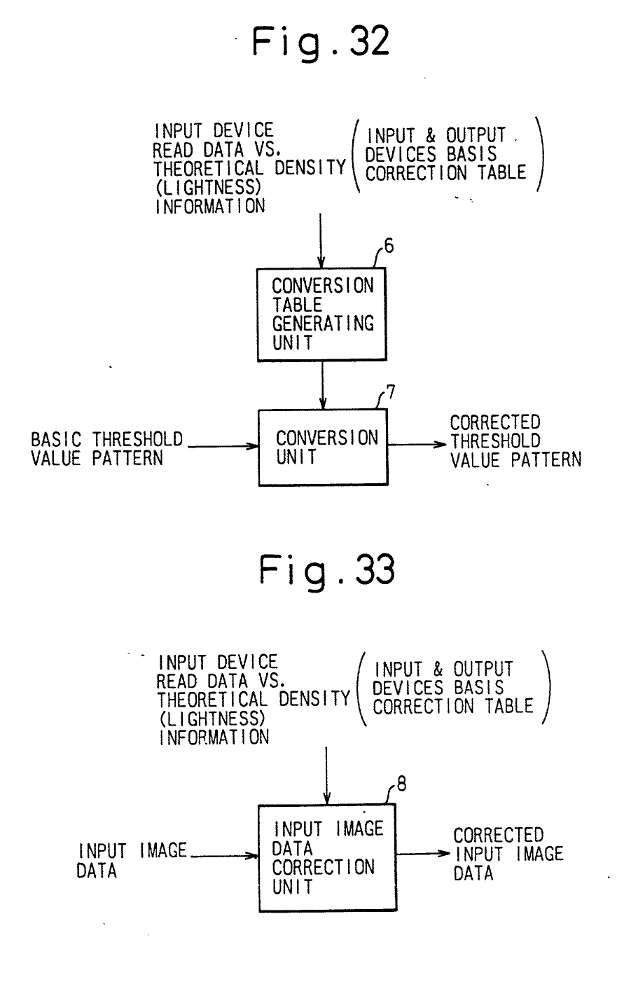

### CONSTRUCTION OF PRODUCING CORRECTED THRESHOLD VALUE PATTERN (FIG. 32)

FIG. 32 is a block diagram illustrating a construction for producing the conversion table, for example, as indicated in FIGS. 20 and 27, and converting the basic threshold value pattern into the corrected threshold value pattern. In the construction of FIG. 32, the conversion table generation unit 6 generates the conversion table as explained with reference to FIG. 20 or 27, and the conversion unit 7 converts, by using the conversion table, the threshold values in the basic (conventional) threshold value pattern into the corrected threshold values which constitutes the corrected threshold value pattern. In the construction of FIG. 32, the production of the conversion table may be carried out in advance, and the produced conversion table may be stored for being supplied for use in the conversion unit 7.

In the applications wherein the output characteristics of the image output device need not be considered, for example, in the case wherein the output characteristic of the image output device is ignorable, the above conversion table may be produced based on the relationship between the density (or lightness) detection values and the actual density values, or the input device basis correction data (table).

In the applications wherein the input characteristics of the image input device need not be considered, for example, in the case the multi-valued image data is produced by digital image processing, the above conversion table may be produced based on the relationship between the theoretical and actual density (or lightness) values, or the output device basis correction data (table).

Each of these units 6 and 7 may be realized with hardware circuitry, a programed computer, or any combination of them, and in the system construction of FIG. 11, the data processing apparatus 200 can realize the functions of these units 6 and 7.

### CONSTRUCTION OF CORRECTING INPUT IMAGE DATA (FIG. 33)

FIG. 33 is a block diagram illustrating an example construction for correcting input image data based on the relationship between the detection output values of the image input device and the theoretical density (or lightness) values, or based on the input & output device basis correction table as indicated in FIGS. 19 and 26.

Although, in all of the processes explained above, the threshold value pattern is converted based on the input device basis, output device basis, or input & output device basis correction data (table), the correction may be performed on the multi-valued image data, instead of the threshold values in the threshold value pattern. The construction of FIG. 33 is provided for this purpose. The input image data correction unit 8 receives the multi-valued image data which is output from the image input device, and converts it into corrected image data, where the conversion (correction) is made based on the relationship between the detection output values of the image input device and the theoretical density (or lightness) values. In this conversion, the multi-valued image data is converted from the scanner output value basis to the theoretical density (or lightness) value basis. Therefore, for example, the conversion tables of FIGS. 20 and 27, which are used for conversion from the theoretical density (or lightness) value basis to the scanner output value basis, are unnecessary.

In the applications wherein the output characteristics of the image output device need not be considered, for example, in the case wherein the output characteristic of the image output device is ignorable, the above conversion may be performed based on the relationship between the density (or lightness) detection values and the actual density values, or the input device basis correction data (table).

In the applications wherein the input characteristics of the image input device need not be considered, for example, in the case the multi-valued image data is produced by digital image processing, the above conversion may be performed based on the relationship between the theoretical and actual density (or lightness) values, or the output device basis correction data (table).

The unit 8 may be realized with hardware circuitry, a programed computer, or any combination of them, and in the system construction of FIG. 11, the data processing apparatus 200 can realize the function of the unit 8.

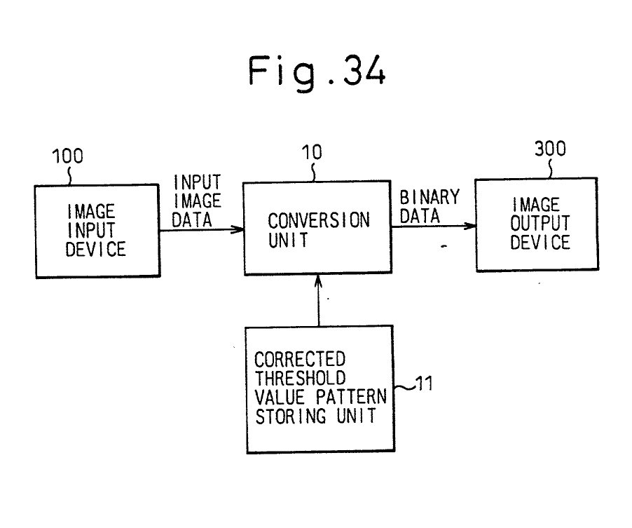

### CONSTRUCTION OF CONVERSION BY CORRECTED THRESHOLD VALUE PATTERN (FIG. 34)

FIG. 34 is a block diagram illustrating the construction for converting multi-valued image data into binary image data, wherein the corrected threshold value pattern is stored outside the conversion unit 10. In FIG. 34, the conversion unit 10 performs the conversion from the multi-valued image data into binary image data, and the corrected threshold value pattern is stored in the corrected threshold value pattern storing unit 11, and is supplied to the conversion unit 10. The above corrected threshold-value pattern may be obtained in advance by any of the processes described in this specification.

The unit 10 may be realized with hardware circuitry, a programed computer, or any combination of them, and in the system construction of FIG. 11, the data processing apparatus 200 can realize the function of the unit 10.

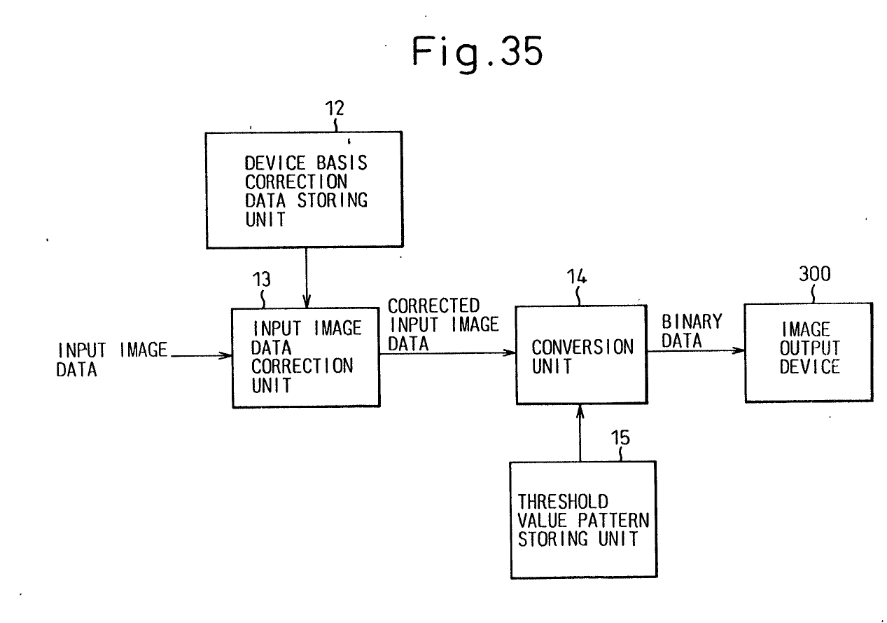

### CONSTRUCTION OF CORRECTING INPUT IMAGE DATA BY CORRECTION DATA (FIG. 35)

FIG. 35 is a block diagram illustrating the basic construction for converting multi-valued image data into binary image data, wherein correction data for correcting image data is stored outside the correction unit. In FIG. 35, the conversion unit 14 performs the conversion from the multi-valued image data into binary image data by using the conventional threshold value pattern which is stored in the threshold value pattern storing unit 15, and the input image data correction unit 13 corrects the input image data by using the input device basis, output device basis, or input & output device basis correction data,,which is stored in the device correction data storing unit 12.

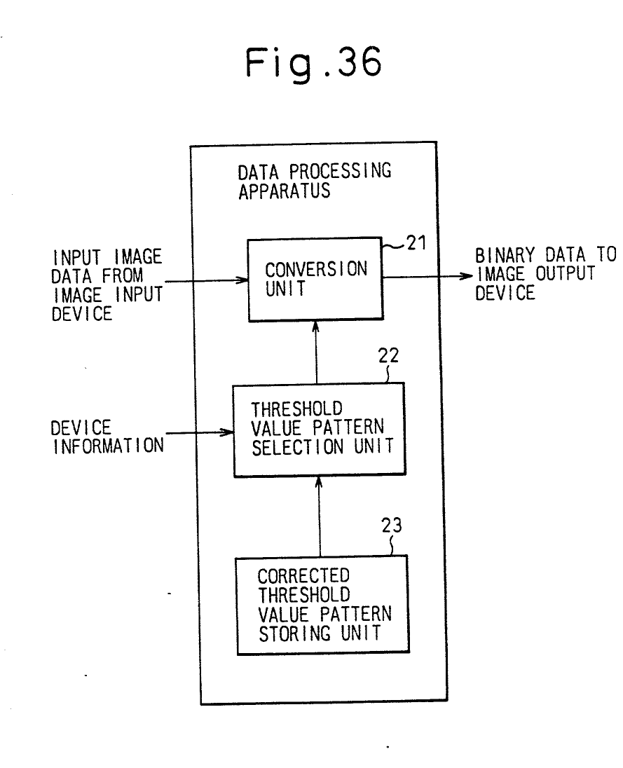

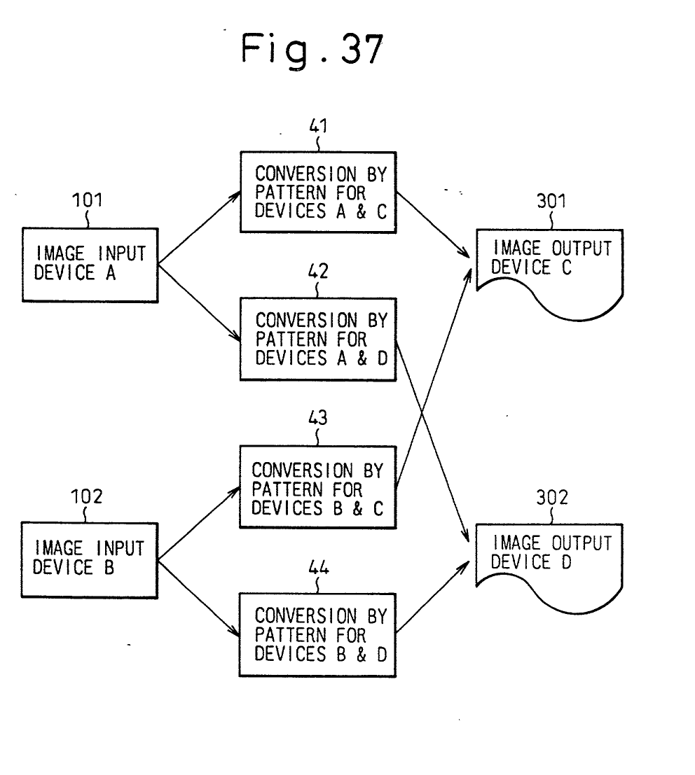

### CONSTRUCTION OF SELECTING THRESHOLD VALUE PATTERN (FIGS. 36 AND 37)

FIG. 36 is a block diagram illustrating a construction for converting multi-valued image data into binary image data, wherein a plurality of corrected threshold value patterns are stored in the threshold value pattern storing unit 23 outside the conversion unit 21. In the construction of FIG. 36, the plurality of threshold value patterns are provided corresponding to a plurality of image input devices, a plurality of image output devices, or a plurality of combinations of at least one image input device and at least one image output device. The threshold value pattern selection unit 22 can receive a device instruction from outside, and the device instruction indicates which of the plurality of image input devices, which of the plurality of image out put devices, or which of the plurality of combinations, is to be used as an image input device, or as an image output device, or as a combination of an image input device and an image output device. In the system construction of FIG. 11, the device instruction may be supplied to the data processing apparatus through the terminal 100. In response to the device instruction, the threshold value pattern selection unit 22 selects the threshold value pattern, which is provided for the instructed one of the plurality of image input devices, the instructed one of the plurality of image output devices, or the instructed one the plurality of combinations, and the selected one of the plurality of threshold value patterns is supplied to the conversion unit 21.

FIG. 37 is an explanatory diagram illustrating the process performed in the construction of FIG. 36 in the case wherein the corrected threshold value pattern storing unit 23 stores a plurality of threshold value patterns for two image input devices A and B, and two image output devices C and D.

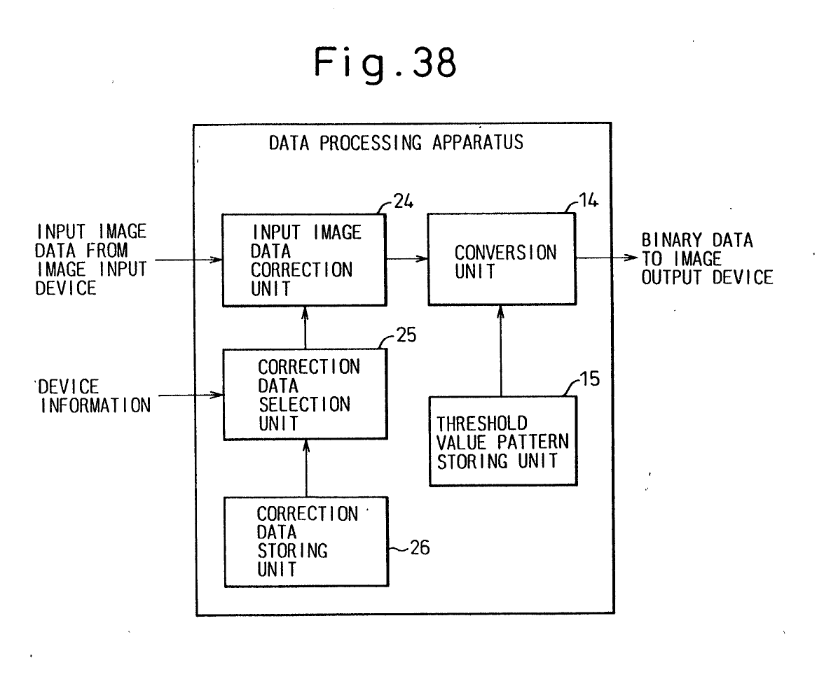

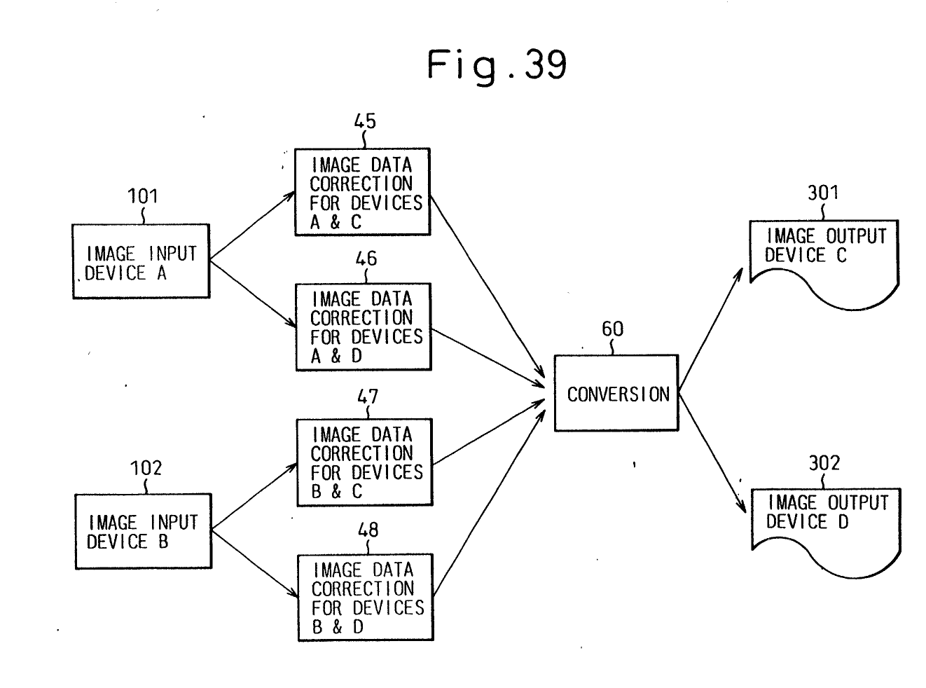

### CONSTRUCTION OF SELECTING CORRECTION DATA (FIGS. 38 AND 39)

FIG. 38 is a block diagram illustrating the basic construction for converting multi-valued image data into binary image data, wherein a plurality of sets of correction data for correcting image data are stored in the correction data storing unit 26 outside the correction unit 24. In the construction of FIG. 38, the plurality of sets of correction data are provided corresponding to a plurality of image input devices, a plurality of image output devices, or a plurality of combinations of at least one image input device and at least one image output device. The correction data selection unit 25 can receive a device instruction from outside, and the device instruction indicates which of the plurality of image input devices, which of the plurality of image output devices, or which of the plurality of combinations, is to be used as an image input device, or as an image output device, or as a combination of an image input device and an image output device: In the system construction of FIG. 11, the device instruction may be supplied to the data processing apparatus through the terminal 100. In response to the device instruction, the correction data selection unit 22 selects the correction data, which is provided for the instructed one of the plurality of image input devices, the instructed one of the plurality of image output devices, or the instructed one the plurality of combinations, and the selected one of the plurality of sets of correction data is supplied to the conversion unit 24.

FIG. 39 is an explanatory diagram illustrating the process performed in the construction of FIG. 38 in the case wherein the correction data storing unit 26 stores a plurality of threshold value patterns for two image input devices A and B, and two image output devices C and D.

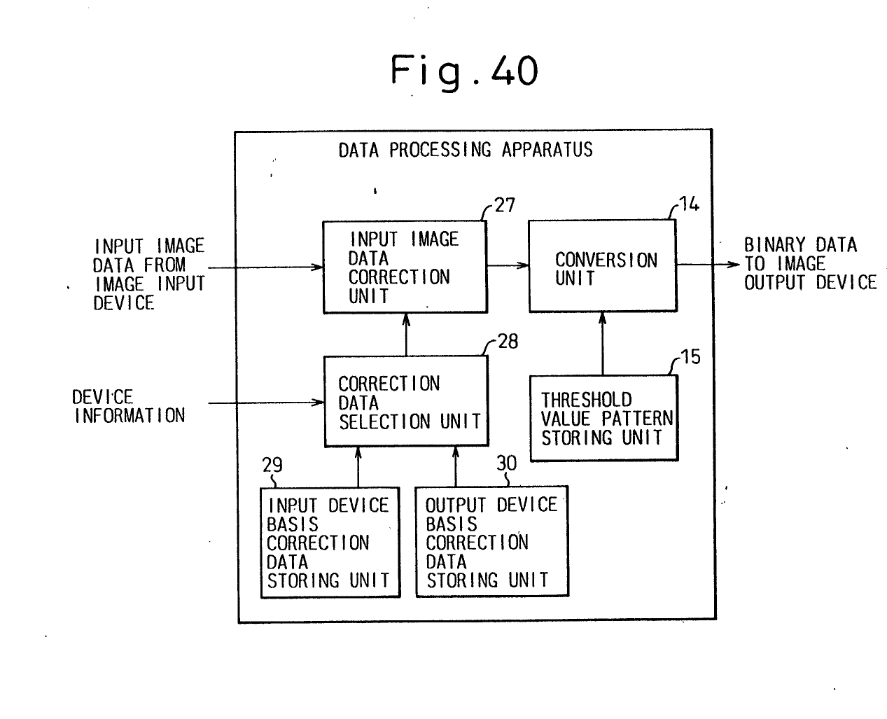

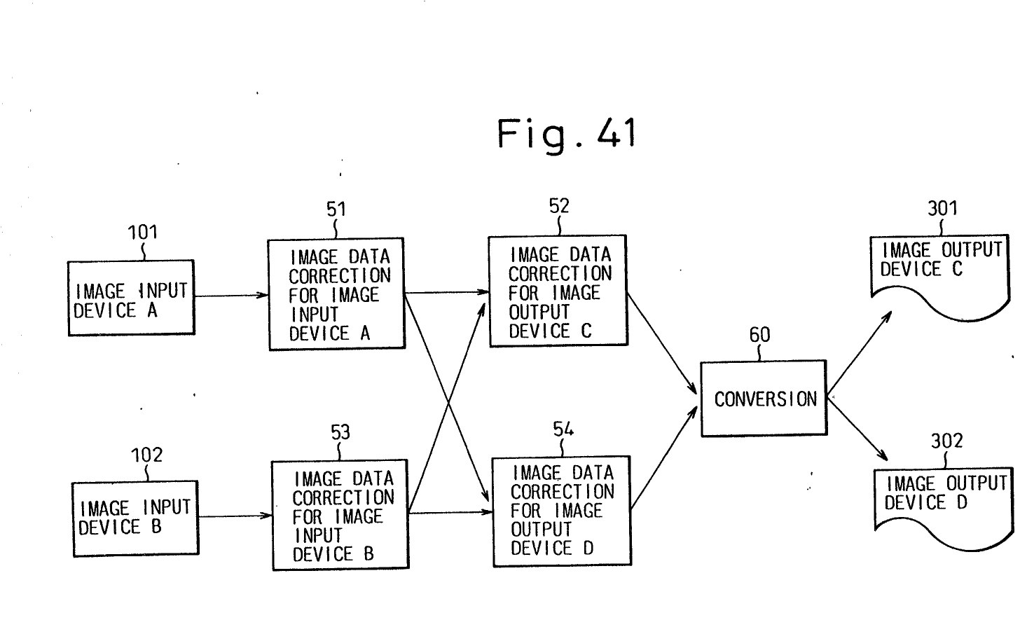

### CONSTRUCTION OF INDIVIDUALLY SELECTING CORRECTION DATA FOR INPUT AND OUTPUT DEVICES (FIGS. 40 AND 41)

FIG. 40 is a block diagram illustrating the basic construction for converting multi-valued image data into binary image data, wherein at least one set of input device basis correction data and at least one set of output device basis correction data are stored outside the correction unit. In FIG. 40, the at least one set of input device basis correction data is stored in the input device basis correction data storing unit 29, and the at least one set of output device basis correction data is stored in the output device basis correction data storing unit 30. The at least one set of input device basis correction data is provided for at least one image input device, and the at least one set of output device basis correction data is provided for at least one image output device. The correction data selection unit 28 can receive a device instruction from outside, and the device instruction contains first and second information. The first information indicates which of the at least one image input device is to be used as an image input device, and the second information indicates which of the at least one image output device is to be used as an image output device. In the system construction of FIG. 11, the device instruction may be supplied to the data processing apparatus through the terminal 100. In response to the device instruction, the correction data selection unit 28 selects one set of correction data, which is provided for the instructed one of the at least one image input device, from the input device basis correction data storing unit 29, and one set of correction data, which is provided for the instructed one of the at least one image output device, from the output device basis correction data storing unit 30. The selected sets of correction data are supplied to the conversion unit 24. In this case, the input image data correction unit 27 receives one set of input device basis correction data such as the correction table indicated in FIG. 15, and one set of output device basis correction data such as the correction table indicated in FIG. 18. Therefore, the input image data correction unit 27 can obtain an input and output device basis correction data such as the table indicated in FIG. 18, based on the received two sets of correction data.

FIG. 41 is an explanatory diagram illustrating the process performed in the construction of FIG. 40 in the case wherein the correction data storing unit 29 stores two sets of correction data for two image input devices A and B, and the correction data storing unit 30 stores two sets of correction data for two image output devices C and D.

### STORAGE MEDIUM STORING PROGRAM OF PROCESS EXECUTION

Any of the processes explained above can be executed by a programmable machine such as a computer and a program which instructs the programmable machine to execute the process can be stored in a computer-readable storage medium such as a floppy disc, a CD-ROM, or a ROM, for use with the programmable machine.

1. A process for producing a threshold value pattern which is used for converting multi-valued image data into binary image data, where said multi-valued image data is obtained for a plurality of pixels by an image input device which detects a predetermined one of density and lightness of each pixel of an original image, said process comprising the steps of:
(a) obtaining information on a detection characteristic for said predetermined one of density and lightness in the image input device;
(b) obtaining a basic threshold value pattern containing a plurality of elements which indicate threshold values for the plurality of pixels; and
(c) converting the threshold values into corrected threshold values for the plurality of pixels, respectively, based on said information on the detection characteristic.

2. A process according to claim 1, wherein said information is obtained by measuring densities of a plurality of sample images by both said image input device and another device for measuring said predetermined one of density and lightness with high accuracy, and obtaining a relationship between a plurality of first values of said predetermined one of density and lightness for the plurality of pixels obtained by measurement by the image input device and a plurality of second values of said predetermined one of density and lightness for the plurality of pixels obtained by measurement by said another device.

3. A process according to claim 2, wherein step (c) comprises the sub-steps of,
(c1) generating a conversion table for converting the threshold values into the corrected threshold values for the plurality of pixels, respectively, based on said relationship, and
(c2) converting the threshold values into the corrected threshold values for the plurality of pixels by using the conversion table.

4. An apparatus for producing a threshold value pattern which is used for converting multi-valued image data into binary image data, where said multi-valued image data is obtained for a plurality of pixels by an image input device which detects a predetermined one of density and lightness of each pixel of an original image, said apparatus comprising:
characteristic information input means for inputting information on a detection characteristic for said predetermined one of density and lightness in the image input device;
basic threshold value pattern obtaining means for obtaining a basic threshold value pattern containing a plurality of elements which indicate threshold values for the plurality of pixels; and
conversion means for converting the threshold values into corrected threshold values for the plurality of pixels, respectively, based on said information on the detection characteristic.

5. An apparatus according to claim 4, wherein said information is obtained by measuring densities of a plurality of sample images by both said image input device and another device for measuring said predetermined one of density and lightness with high accuracy, and obtaining a relationship between a plurality of first values of said predetermined one of density and lightness for the plurality of pixels obtained by measurement by the image input device and a plurality of second values of said predetermined one of density and lightness for the plurality of pixels obtained by measurement by said another device.

6. An apparatus according to claim 5, further comprising means for generating a conversion table for converting the threshold values into the corrected threshold values for the plurality of pixels, respectively, based on said relationship, and
said conversion means converts the threshold values into the corrected threshold values for the plurality of pixels by using the conversion table.

7. A computer-readable storage medium in which a program is stored, where said program, when used with a computer, directs the computer to execute a process for producing a threshold value pattern which is used for converting multi-valued image data into binary image data, where said multi-valued image data is obtained for a plurality of pixels by an image input device which detects a predetermined one of density and lightness of each pixel of an original image, said process comprising the steps of:
(a) obtaining information on a detection characteristic for said predetermined one of density and lightness in the image input device;
(b) obtaining a basic threshold value pattern containing a plurality of elements which indicate threshold values for the plurality of pixels; and
(c) converting the threshold values into corrected threshold values for the plurality of pixels, respectively, based on said information on the detection characteristic.

8. A computer-readable storage medium according to claim 7, wherein said information is obtained by measuring densities of a plurality of sample images by both said image input device and another device for measuring said predetermined one of density and lightness with high accuracy, and obtaining a relationship between a plurality of first values of said predetermined one of density and lightness for the plurality of pixels obtained by measurement by the image input device and a plurality of second values of said predetermined one of density and lightness for the plurality of pixels obtained by measurement by said another device.

9. A computer-readable storage medium according to claim 8, wherein step (c) comprises the sub-steps of:
(c1) generating a conversion table for converting the threshold values into the corrected threshold values for the plurality of pixels, respectively, based on said relationship, and
(c2) converting the threshold values into the corrected threshold values for the plurality of pixels by using the conversion table.

10. A process for producing a threshold value pattern which is used for converting multi-valued image data for a plurality of pixels into binary image data, where said binary image data is to be output as a visible output image by an image output device, said process comprising the steps of:
(a) obtaining information on an output characteristic of the image output device;
(b) obtaining a basic threshold value pattern containing a plurality of elements which indicate threshold values for the plurality of pixels; and
(c) converting the threshold values into corrected threshold values for the plurality of pixels, respectively, based on said information on the output characteristic.

11. A process according to claim 10, wherein said information is obtained by measuring an actual size of a dot which is output by said image output device in correspondence with a theoretical size of the dot to obtain as a dot gain a ratio of the actual dot size to the theoretical dot size, and
in step (c), the conversion of the threshold values into the corrected threshold values is performed based on the dot gain.

12. A process according to claim 11, further comprising the sub-step of,
(c1) obtaining a plurality of actual halftone dot ratios for a plurality of theoretical halftone dot ratios based on said dot gain, to obtain a first relationship between the plurality of actual halftone dot ratios and the plurality of theoretical halftone dot ratios.

13. A process according to claim 12, wherein step (c) further comprises the sub-steps of,
(c2) obtaining a first reference value of said predetermined one of density and lightness of a background area of said visible output image, and a second reference value of said predetermined one of density and lightness of an area within the dot,
(c3) calculating a plurality of values of said predetermined one of density and lightness for the plurality of the theoretical halftone dot ratios based on said first and second reference values, to obtain a second relationship between the plurality of values of said predetermined one of density and lightness and the plurality of the theoretical halftone dot ratios,
(c4) obtaining a third relationship between a plurality of theoretical values of said predetermined one of density and lightness and a plurality of actual values of said predetermined one of density and lightness based on the first and second relationships, and
(c5) converting the threshold values into the corrected threshold values for the plurality of pixels, respectively, based on the third relationship.

14. A process according to claim 13, wherein step (c5) further comprises the sub-steps of,
(c6) generating a conversion table for converting the threshold values into the corrected threshold values for the plurality of pixels, respectively, based on said third relationship, and
(c7) converting the threshold values into the corrected threshold values for the plurality of pixels by using the conversion table.

15. An apparatus for producing a threshold value pattern which is used for converting multi-valued image data for a plurality of pixels into binary image data, where said binary image data is to be output as a visible output image by an image output device, said apparatus comprising:
characteristic information input means for inputting information on an output characteristic of the image output device;
basic threshold value pattern obtaining means for obtaining a basic threshold value pattern containing a plurality of elements which indicate threshold values for the plurality of pixels; and
conversion means for converting the threshold values into corrected threshold values for the plurality of pixels, respectively, based on said information on the output characteristic.

16. An apparatus according to claim 15, wherein said information is obtained by measuring an actual size of a dot which is output by said image output device in correspondence with a theoretical size of the dot to obtain as a dot gain a ratio of the actual dot size to the theoretical dot size, and
the conversion of the threshold values into the corrected threshold values is performed by said conversion means based on the dot gain.

17. An apparatus according to claim 16, further comprising means for obtaining a plurality of actual halftone dot ratios for a plurality of theoretical halftone dot ratios based on said dot gain, to obtain a first relationship between the plurality of actual halftone dot ratios and the plurality of theoretical halftone dot ratios.

18. An apparatus according to claim 17, wherein step (c) further comprises,
reference obtaining means for obtaining a first reference value of said predetermined one of density and lightness of a background area of said visible output image, and a second reference value of said predetermined one of density and lightness of an area within the dot, and
calculating means for calculating a plurality of values of said predetermined one of density and lightness for the plurality of the theoretical halftone dot ratios based on said first and second reference values, to obtain a second relationship between the plurality of values of said predetermined one of density and lightness and the plurality of the theoretical halftone dot ratios, and
conversion relationship obtaining means for obtaining a third relationship between a plurality of theoretical values of said predetermined one of density and lightness and a plurality of actual values of said predetermined one of density and lightness based on the first and second relationships, and
said conversion means converts the threshold values into the corrected threshold values for the plurality of pixels, respectively, based on the third relationship.

19. An apparatus according to claim 18, said conversion means further comprises,
means for generating a conversion table for converting the threshold values into the corrected threshold values for the plurality of pixels, respectively, based on said third relationship, and
means for converting the threshold values into the corrected threshold values for the plurality of pixels by using the conversion table.

20. A computer-readable storage medium in which a program is stored, where said program, when used with a computer, directs the computer to execute a process for producing a threshold value pattern which is used for converting multi-valued image data for a plurality of pixels into binary image data, where said binary image data is to be output as a visible output image by an image output device, said process comprising the steps of:
(a) obtaining information on an output characteristic of the image output device;
(b) obtaining a basic threshold value pattern containing a plurality of elements which indicate threshold values for the plurality of pixels; and
(c) converting the threshold values into corrected threshold values for the plurality of pixels, respectively, based on said information on the output characteristic.

21. A computer-readable storage medium according to claim 20, wherein said information is obtained by measuring an actual size of a dot which is output by said image output device in correspondence with a theoretical size of the dot to obtain as a dot gain a ratio of the actual dot size to the theoretical dot size, and
in step (c), the conversion of the threshold values into the corrected threshold values is performed based on the dot gain.

22. A computer-readable storage medium according to claim 21, wherein step (c) further comprises the sub-step of,
(c1) obtaining a plurality of actual halftone dot ratios for a plurality of theoretical halftone dot ratios based on said dot gain, to obtain a first relationship between the plurality of actual halftone dot ratios and the plurality of theoretical halftone dot ratios.

23. A computer-readable storage medium according to claim 22, wherein step (c) further comprises the sub-steps of,
(c2) obtaining a first reference value of said predetermined one of density and lightness of a background area of said visible output image, and a second reference value of said predetermined one of density and lightness of an area within the dot,
(c3) calculating a plurality of values of said predetermined one of density and lightness for the plurality of the theoretical halftone dot ratios based on said first and second reference values, to obtain a second relationship between the plurality of values of said predetermined one of density and lightness and the plurality of the theoretical halftone dot ratios,
(c4) obtaining a third relationship between a plurality of theoretical values of said predetermined one of density and lightness and a plurality of actual values of said predetermined one of density and lightness based on the first and second relationships, and
(c5) converting the threshold values into the corrected threshold values for the plurality of pixels, respectively, based on the third relationship.

24. A computer-readable storage medium according to claim 23, wherein step (c5) further comprises the sub-steps of,
(c6) generating a conversion table for converting the threshold values into the corrected threshold values for the plurality of pixels, respectively, based on said third relationship, and
(c7) converting the threshold values into the corrected threshold values for the plurality of pixels by using the conversion table.

25. A process for producing a threshold value pattern which is used for converting multi-valued image data into binary image data, where said multi-valued image data is obtained for a plurality of pixels by an image input device which detects a predetermined one of density and lightness of each pixel of an original image, and said binary image data is to be output as a visible output image by an image output device, said process comprising the steps of:
(a) obtaining first information on a detection characteristic for said predetermined one of density and lightness in the image input device;
(b) obtaining second information on an output characteristic of the image output device;
(c) obtaining a basic threshold value pattern containing a plurality of elements which indicate threshold values for the plurality of pixels; and
(d) converting the threshold values into corrected threshold values for the plurality of pixels, respectively, based on said first and second information.

26. A process according to claim 25, wherein said first information is obtained by measuring densities of a plurality of sample images by both said image input device and another device for measuring said predetermined one of density and lightness with high accuracy, and obtaining a first relationship between a plurality of first values of said predetermined one of density and lightness for the plurality of pixels obtained by measurement by the image input device and a plurality of second values of said predetermined one of density and lightness for the plurality of pixels obtained by measurement by said another device.

27. A process according to claim 26, wherein said information is obtained by measuring an actual size of a dot which is output by said image output device in correspondence with a theoretical size of the dot to obtain as a dot gain a ratio of the actual dot size to the theoretical dot size, and
in step (d), the conversion of the threshold values into the corrected threshold values is performed based on the first relationship and the dot gain.

28. A process according to claim 27, wherein step (d) comprises the sub-steps of,
(d1) generating a conversion table for converting the threshold values into the corrected threshold values for the plurality of pixels, respectively, based on said first relationship and the dot gain, and
(d2) converting the threshold values into the corrected threshold values for the plurality of pixels by using the conversion table.

29. A process according to claim 27, wherein step (d) further comprising the sub-step of,
(d3) obtaining a plurality of actual halftone dot ratios for a plurality of theoretical halftone dot ratios based on said dot gain, to obtain a second relationship between the plurality of actual halftone dot ratios and the plurality of theoretical halftone dot ratios.

30. A process according to claim 29, wherein step (d) further comprises the sub-steps of,
(d4) obtaining a first reference value of said predetermined one of density and lightness of a background area of said visible output image, and a second reference value of said predetermined one of density and lightness of an area within the dot, and
(d5) calculating a plurality of values of said predetermined one of density and lightness for the plurality of the theoretical halftone dot ratios based on said first and second reference values, to obtain a third relationship between the plurality of values of said predetermined one of density and lightness and the plurality of the theoretical halftone dot ratios,
(d6) obtaining a fourth relationship between a plurality of theoretical values of said predetermined one of density and lightness and a plurality of actual values of said predetermined one of density and lightness based on the second and third relationships,
(d7) obtaining a fifth relationship between the plurality of first values of said predetermined one of density and lightness for the plurality of pixels obtained by measurement by the image input device, and the plurality of theoretical values of said predetermined one of density and lightness, based on the first and fourth relationship, and
(d8) converting the threshold values into the corrected threshold values for the plurality of pixels, respectively, based on the fifth relationship.

31. A process according to claim 30, wherein step (d8) further comprises the sub-steps of,
(d9) generating a conversion table for converting the threshold values into the corrected threshold values for the plurality of pixels, respectively, based on said fifth relationship, and
(d10) converting the threshold values into the corrected threshold values for the plurality of pixels by using the conversion table.

32. An apparatus for producing a threshold value pattern which is used for converting multi-valued image data into binary image data, where said multi-valued image data is obtained for a plurality of pixels by an image input device which detects a predetermined one of density and lightness of each pixel of an original image, and said binary image data is to be output as a visible output image by an image output device, said apparatus comprising:
first information obtaining means for obtaining first information on a detection characteristic for said predetermined one of density and lightness in the image input device;
second information obtaining means for obtaining second information on an output characteristic of the image output device;
basic threshold value pattern obtaining means for obtaining a basic threshold value pattern containing a plurality of elements which indicate threshold values for the plurality of pixels; and
conversion means for converting the threshold values into corrected threshold values for the plurality of pixels, respectively, based on said first and second information.

33. An apparatus according to claim 32, wherein said first information is obtained by measuring densities of a plurality of sample images by both said image input device and another device for measuring said predetermined one of density and lightness with high accuracy, and obtaining a first relationship between a plurality of first values of said predetermined one of density and lightness for the plurality of pixels obtained by measurement by the image input device and a plurality of second values of said predetermined one of density and lightness for the plurality of pixels obtained by measurement by said another device.

34. An apparatus according to claim 33, wherein said information is obtained by measuring an actual size of a dot which is output by said image output device in correspondence with a theoretical size of the dot to obtain as a dot gain a ratio of the actual dot size to the theoretical dot size, and
in said conversion means, the conversion of the threshold values into the corrected threshold values is performed based on the first relationship and the dot gain.

35. An apparatus according to claim 34, said conversion means comprises,
means for generating a conversion table for converting the threshold values into the corrected threshold values for the plurality of pixels, respectively, based on said first relationship and the dot gain, and
means for converting the threshold values into the corrected threshold values for the plurality of pixels by using the conversion table.

36. An apparatus according to claim 34, further comprising,
means for obtaining a plurality of actual halftone dot ratios for a plurality of theoretical halftone dot ratios based on said dot gain, to obtain a second relationship between the plurality of actual halftone dot ratios and the plurality of theoretical halftone dot ratios.

37. An apparatus according to claim 36, said conversion means further comprises,
means for obtaining a first reference value of said predetermined one of density and lightness of a background area of said visible output image, and a second reference value of said predetermined one of density and lightness of an area within the dot, and
means for calculating a plurality of values of said predetermined one of density and lightness for the plurality of the theoretical halftone dot ratios based on said first and second reference values, to obtain a third relationship between the plurality of values of said predetermined one of density and lightness and the plurality of the theoretical halftone dot ratios,
means for obtaining a fourth relationship between a plurality of theoretical values of said predetermined one of density and lightness and a plurality of actual values of said predetermined one of density and lightness based on the second and third relationships,
means for obtaining a fifth relationship between the plurality of first values of said predetermined one of density and lightness for the plurality of pixels obtained by measurement by the image input device, and the plurality of theoretical values of said predetermined one of density and lightness, based on the first and fourth relationship, and
means for converting the threshold values into the corrected threshold values for the plurality of pixels, respectively, based on the fifth relationship.

38. An apparatus according to claim 37, said means for converting, further comprises,
means for generating a conversion table for converting the threshold values into the corrected threshold values for the plurality of pixels, respectively, based on said fifth relationship, and
means for converting the threshold values into the corrected threshold values for the plurality of pixels by using the conversion table.

39. A computer-readable storage medium in which a program is stored, where said program, when used with a computer, directs the computer to execute a process for producing a threshold value pattern which is used for converting multi-valued image data into binary image data, where said multi-valued image data is obtained for a plurality of pixels by an image input device which detects a predetermined one of density and lightness of each pixel of an original image, and said binary image data is to be output as a visible output image by an image output device, said process comprising the steps of:
(a) obtaining first information on a detection characteristic for said predetermined one of density and lightness in the image input device;
(b) obtaining second information on an output characteristic of the image output device;
(c) obtaining a basic threshold value pattern containing a plurality of elements which indicate threshold values for the plurality of pixels; and
(d) converting the threshold values into corrected threshold values for the plurality of pixels, respectively, based on said first and second information.

40. A computer-readable storage medium according to claim 39, wherein said first information is obtained by measuring densities of a plurality of sample images by both said image input device and another device for measuring said predetermined one of density and lightness with high accuracy, and obtaining a first relationship between a plurality of first values of said predetermined one of density and lightness for the plurality of pixels obtained by measurement by the image input device and a plurality of second values of said predetermined one of density and lightness for the plurality of pixels obtained by measurement by said another device.

41. A computer-readable storage medium according to claim 40, wherein said information is obtained by measuring an actual size of a dot which is output by said image output device in correspondence with a theoretical size of the dot to obtain as a dot gain a ratio of the actual dot size to the theoretical dot size, and
in step (d), the conversion of the threshold values into the corrected threshold values is performed based on the first relationship and the dot gain.

42. A computer-readable storage medium according to claim 41, wherein step (d) comprises the sub-steps of,
(d1) generating a conversion table for converting the threshold values into the corrected threshold values for the plurality of pixels, respectively, based on said first relationship and the dot gain, and
(d2) converting the threshold values into the corrected threshold values for the plurality of pixels by using the conversion table.

43. A computer-readable storage medium according to claim 41, wherein step (d) further comprises the sub-step of,
(d3) obtaining a plurality of actual halftone dot ratios for a plurality of theoretical halftone dot ratios based on said dot gain, to obtain a second relationship between the plurality of actual halftone dot ratios and the plurality of theoretical halftone dot ratios.

44. A computer-readable storage medium according to claim 43, wherein step (d) further comprises the sub-steps of,
(d4) obtaining a first reference value of said predetermined one of density and lightness of a background area of said visible output image, and a second reference value of said predetermined one of density and lightness of an area within the dot, and
(d5) calculating a plurality of values of said predetermined one of density and lightness for the plurality of the theoretical halftone dot ratios based on said first and second reference values, to obtain a third relationship between the plurality of values of said predetermined one of density and lightness and the plurality of the theoretical halftone dot ratios,
(d6) obtaining a fourth relationship between a plurality of theoretical values of said predetermined one of density and lightness and a plurality of actual values of said predetermined one of density and lightness based on the second and third relationships,
(d7) obtaining a fifth relationship between the plurality of first values of said predetermined one of density and lightness for the plurality of pixels obtained by measurement by the image input device, and the plurality of theoretical values of said predetermined one of density and lightness, based on the first and fourth relationship, and
(d8) converting the threshold values into the corrected threshold values for the plurality of pixels, respectively, based on the fifth relationship.

45. A computer-readable storage medium according to claim 44, wherein step (d8) further comprises the sub-steps of,
(d9) generating a conversion table for converting the threshold values into the corrected threshold values for the plurality of pixels, respectively, based on said fifth relationship, and
(d10) converting the threshold values into the corrected threshold values for the plurality of pixels by using the conversion table.

46. A process for converting multi-valued image data into binary image data, where said multi-valued image data is obtained for a plurality of pixels by an image input device which detects a predetermined one of density and lightness of each pixel of an original image, said process comprising the steps of:
(a) inputting said multi-valued image data; and
(b) converting said multi-valued image data for the plurality of pixels into the binary image data for the plurality of pixels by respectively comparing said multi-valued image data for the plurality of pixels with threshold values, which are determined in advance so as to be specific to said image input device.

47. A process according to claim 46, wherein said threshold values are generated in advance so that a detection characteristic for said predetermined one of density and lightness in the image input device is reflected therein.

48. A process for converting multi-valued image data into binary image data, where said multi-valued image data is obtained for a plurality of pixels by one of a plurality of image input devices, and said one of the plurality of image input devices detects a predetermined one of density and lightness of each pixel of an original image, said process comprising the steps of:
(a) inputting said multi-valued image data;
(b) inputting an instruction which indicates by which one of the plurality of image input devices said multi-valued image data is obtained;
(c) selecting one of a plurality of threshold value patterns in response to said instruction, where each of said plurality of threshold value patterns contains a plurality of elements which indicate threshold values for the plurality of pixels, and is determined in advance so as to be specific to a respective one of the plurality of image input devices; and
(d) converting said multi-valued image data for the plurality of pixels into the binary image data for the plurality of pixels by respectively comparing said multi-valued image data for the plurality of pixels with threshold values which are contained in said one of said plurality of threshold value patterns selected in step (c).

49. An apparatus for converting multi-valued image data into binary image data, where said multi-valued image data is obtained for a plurality of pixels by an image input device which detects a predetermined one of density and lightness of each pixel of an original image, said apparatus comprising:
data inputting means for inputting said multi-valued image data; and
conversion means for converting said multi-valued image data for the plurality of pixels into the binary image data for the plurality of pixels by respectively comparing said multi-valued image data for the plurality of pixels with threshold values, which are determined in advance so as to be specific to said image input device.

50. An apparatus according to claim 49, wherein said threshold values are generated in advance so that a detection characteristic for said predetermined one of density and lightness in the image input device is reflected therein.

51. An apparatus for converting multi-valued image data into binary image data, where said multi-valued image data is obtained for a plurality of pixels by one of a plurality of image input devices, and said one of the plurality of image input devices detects a predetermined one of density and lightness of each pixel of an original image, said apparatus comprising:
threshold value pattern storing means for storing a plurality of threshold value patterns each containing a plurality of elements which indicate threshold values for the plurality of pixels and each is determined in advance so as to be specific to a respective one of the plurality of image input devices;
data inputting means for inputting said multi-valued image data;
instruction inputting means for inputting an instruction which indicates by which one of the plurality of image input devices said multi-valued image data is obtained;
selection means for selecting one of said plurality of threshold value patterns in response to said instruction; and
conversion means for converting said multi-valued image data for the plurality of pixels into the binary image data for the plurality of pixels by respectively comparing said multi-valued image data for the plurality of pixels with the threshold values which are contained in said one of said plurality of threshold value patterns selected by the selection means.

52. A computer-readable storage medium in which a program is stored, where said program, when used with a computer, directs the computer to execute a process for converting multi-valued image data into binary image data, where said multi-valued image data is obtained for a plurality of pixels by an image input device which detects a predetermined one of density and lightness of each pixel of an original image, said process comprising the steps of:
(a) inputting said multi-valued image data;
(b) inputting an instruction which indicates by which one of the plurality of image input devices said multi-valued image data is obtained;
(c) selecting one of a plurality of threshold value patterns in response to said instruction, where each of said plurality of threshold value patterns contains a plurality of elements which indicate threshold values for the plurality of pixels, and is determined in advance so as to be specific to a respective one of the plurality of image input devices; and
(d) converting said multi-valued image data for the plurality of pixels into the binary image data for the plurality of pixels by respectively comparing said multi-valued image data for the plurality of pixels with threshold values which are contained in said one of said plurality of threshold value patterns selected in step (c).

53. A process for converting multi-valued image data into binary image data, where said binary image data is to be output as a visible output image by an image output device, said process comprising the steps of:
(a) inputting said multi-valued image data; and
(b) converting said multi-valued image data for the plurality of pixels into the binary image data for the plurality of pixels by respectively comparing said multi-valued image data for the plurality of pixels with threshold values, which are determined in advance so as to be specific to said image output device.

54. A process according to claim 53, wherein said threshold values are generated in advance so that an output characteristic of the image output device is reflected therein.

55. A process for converting multi-valued image data into binary image data, where said binary image data is to be output as a visible output image by one of a plurality of image output devices, said process comprising the steps of:
(a) inputting said multi-valued image data;
(b) inputting an instruction which indicates by which one of the plurality of image output devices said binary image data is to be output;
(c) selecting one of a plurality of threshold value patterns in response to said instruction, where each of said plurality of threshold value patterns contains a plurality of elements which indicate threshold values for the plurality of pixels, and is determined in advance so as to be specific to a respective one of the plurality of image output devices; and
(d) converting said multi-valued image data for the plurality of pixels into the binary image data for the plurality of pixels by respectively comparing said multi-valued image data for the plurality of pixels with the threshold values which are contained in said one of said plurality of threshold value patterns selected in step (c).

56. An apparatus for converting multi-valued image data into binary image data, where said binary image data is to be output as a visible output image by an image output device, said apparatus comprising:
data inputting means for inputting said multi-valued image data; and
conversion means for converting said multi-valued image data for the plurality of pixels into the binary image data for the plurality of pixels by respectively comparing said multi-valued image data for the plurality of pixels with threshold values which are determined in advance so as to be specific to said image output device.

57. An apparatus according to claim 56, wherein said threshold values are generated in advance so that an output characteristic of the image output device is reflected therein.

58. An apparatus for converting multi-valued image data into binary image data, where said binary image data is to be output as a visible output image by one of a plurality of image output devices, said apparatus comprising:
threshold value pattern storing means for storing a plurality of threshold value patterns each containing a plurality of elements which indicate threshold values for the plurality of pixels, and each is determined in advance so as to be specific to a respective one of the plurality of image output devices;
data inputting means for inputting said multi-valued image data;
instruction inputting means for inputting an instruction which indicates by which one of the plurality of image output devices said binary image data is to be output;
selection means for selecting one of said plurality of threshold value patterns in response to said instruction; and
conversion means for converting said multi-valued image data for the plurality of pixels into the binary image data for the plurality of pixels by respectively comparing said multi-valued image data for the plurality of pixels with the threshold values which are contained in said one of said plurality of threshold value patterns selected by the selection means.

59. A computer-readable storage medium in which a program is stored, where said program, when used with a computer, directs the computer to execute a process for converting multi-valued image data into binary image data, where said binary image data is to be output as a visible output image by one of a plurality of image output devices, said process comprising the steps of:
(a) inputting said multi-valued image data;
(b) inputting an instruction which indicates by which one of the plurality of image output devices said binary image data is to be output;
(c) selecting one of a plurality of threshold value patterns in response to said instruction, where each of said plurality of threshold value patterns contains a plurality of elements which indicate threshold values for the plurality of pixels, and is determined in advance so as to be specific to a respective one of the plurality of image output devices; and
(d) converting said multi-valued image data for the plurality of pixels into the binary image data for the plurality of pixels by respectively comparing said multi-valued image data for the plurality of pixels with the threshold values which are contained in said one of said plurality of threshold value patterns selected in step (c).

60. A process for converting multi-valued image data into binary image data, where said multi-valued image data is obtained for a plurality of pixels by an image input device which detects a predetermined one of density and lightness of each pixel of an original image, and said binary image data is to be output as a visible output image by an image output device, said process comprising the steps of:
(a) inputting said multi-valued image data; and
(b) converting said multi-valued image data for the plurality of pixels into the binary image data for the plurality of pixels by respectively comparing said multi-valued image data for the plurality of pixels with threshold values which are determined in advance so as to be specific to a combination of said image input device and said image output device.

61. A process according to claim 60, wherein said threshold values are generated in advance so that a detection characteristic for said predetermined one of density and lightness in the image input device and an output characteristic of the image output device are reflected therein.

62. A process for converting multi-valued image data into binary image data, where said multi-valued image data is obtained for a plurality of pixels by one of at least one image input device, said one of the at least one image input device detects a predetermined one of density and lightness of each pixel of an original image, and said binary image data is to be output as a visible output image by one of at least one image output device, said process comprising the steps of:
(a) inputting said multi-valued image data;
(b) inputting an instruction which indicates by which one of a plurality of combinations of the at least one image input device and the at least one image output device said multi-valued image data is obtained and said binary image data is to be output, respectively;
(c) selecting one of a plurality of threshold value patterns in response to said instruction, where each of said plurality of threshold value patterns contains a plurality of elements which indicate threshold values for the plurality of pixels, and is determined in advance so as to be specific to a respective one of a plurality of possible combinations of the at least one image input device and the at least one image output device; and
(d) converting said multi-valued image data for the plurality of pixels into the binary image data for the plurality of pixels by respectively comparing said multi-valued image data for the plurality of pixels with threshold values which are contained in said one of said plurality of threshold value patterns selected in step (c).

63. An apparatus for converting multi-valued image data into binary image data, where said multi-valued image data is obtained for a plurality of pixels by an image input device which detects a predetermined one of density and lightness of each pixel of an original image, and said binary image data is to be output as a visible output image by an image output device, said apparatus comprising:
data inputting means for inputting said multi-valued image data; and
conversion means for converting said multi-valued image data for the plurality of pixels into the binary image data for the plurality of pixels by respectively comparing said multi-valued image data for the plurality of pixels with threshold values which are determined in advance so as to be specific to a combination of said image input device and said image output device.

64. An apparatus according to claim 63, wherein said threshold values are generated in advance so that a detection characteristic for said predetermined one of density and lightness in the image input device and an output characteristic of the image output device are reflected therein.

65. An apparatus for converting multi-valued image data into binary image data, where said multi-valued image data is obtained for a plurality of pixels by one of at least one image input device, said one of the at least one image input device detects a predetermined one of density and lightness of each pixel of an original image, and said binary image data is to be output as a visible output image by one of at least one image output device, said apparatus comprising:
threshold value pattern storing means for storing a plurality of threshold value patterns each containing a plurality of elements which indicate threshold values for the plurality of pixels, and each is determined in advance so as to be specific to a respective one of a plurality of possible combinations of the at least one image input device and the at least one image output device;
instruction inputting means for inputting an instruction which indicates by which one of a plurality of combinations of the at least one image input device and the at least one image output device said multi-valued image data is obtained and said binary image data is to be output, respectively;
selection means for selecting one of said plurality of threshold value patterns in response to said instruction; and
conversion means for converting said multi-valued image data for the plurality of pixels into the binary image data for the plurality of pixels by respectively comparing said multi-valued image data for the plurality of pixels with the threshold values which are contained in said one of said plurality of threshold value patterns selected by the selection means.

66. A computer-readable storage medium in which a program is stored, where said program, when used with a computer, directs the computer to execute a process for converting multi-valued image data into binary image data, where said multi-valued image data is obtained for a plurality of pixels by one of at least one image input device, said one of the at least one image input device detects a predetermined one of density and lightness of each pixel of an original image and said binary image data is to be output as a visible output image by one of at least one image output device, said process comprising the steps of:
(a) inputting said multi-valued image data;
(b) inputting an instruction which indicates by which one of a plurality of combinations of the at least one image input device and the at least one image output device said multi-valued image data is obtained and said binary image data is to be output, respectively;
(c) selecting one of a plurality of threshold value patterns in response to said instruction, where each of said plurality of threshold value patterns contains a plurality of elements which indicate threshold values for the plurality of pixels, and is determined in advance so as to be specific to a respective one of a plurality of possible combinations of the at least one image input device and the at least one image output device; and
(d) converting said multi-valued image data for the plurality of pixels into the binary image data for the plurality of pixels by respectively comparing said multi-valued image data for the plurality of pixels with threshold values which are contained in said one of said plurality of threshold value patterns selected in step (c).

67. A process for converting multi-valued image data into binary image data, where said multi-valued image data is obtained for a plurality of pixels by an image input device which detects a predetermined one of density and lightness of each pixel of an original image, said process comprising the steps of:
(a) inputting said multi-valued image data;
(b) converting said multi-valued image data for the plurality of pixels into corrected multi-valued image data in accordance with correction data which is determined in advance so as to be specific to said image input device; and
(c) converting said corrected multi-valued image data for the plurality of pixels into the binary image data for the plurality of pixels by comparing said corrected multi-valued image data for the plurality of pixels with predetermined threshold values, respectively.

68. A process according to claim 67, wherein said correction data is generated in advance so that a detection characteristic for said predetermined one of density and lightness in the image input device is reflected therein.

69. A process for converting multi-valued image data into binary image data, where said multi-valued image data is obtained for a plurality of pixels by one of a plurality of image input devices, and said one of the plurality of image input devices detects a predetermined one of density and lightness of each pixel of an original image, said process comprising the steps of:
(a) inputting said multi-valued image data;
(b) inputting an instruction which indicates by which one of the plurality of image input devices said multi-valued image data is obtained;
(c) selecting one of a plurality of sets of correction data in response to said instruction, where each of said plurality of sets of correction data is determined in advance so as to be specific to a respective one of the plurality of image input devices;
(d) converting said multi-valued image data for the plurality of pixels into corrected multi-valued image data in accordance with said one of the plurality of sets of correction data which is selected in step (c); and
(e) converting said corrected multi-valued image data for the plurality of pixels into the binary image data for the plurality of pixels by comparing said corrected multi-valued image data for the plurality of pixels with predetermined threshold values, respectively.

70. An apparatus for converting multi-valued image data into binary image data, where said multi-valued image data is obtained for a plurality of pixels by an image input device which detects a predetermined one of density and lightness of each pixel of an original image, said apparatus comprising:
data inputting means for inputting said multi-valued image data; and
correction means for converting said multi-valued image data for the plurality of pixels into corrected multi-valued image data in accordance with correction data which is determined in advance so as to be specific to said image input device; and
conversion means for converting said corrected multi-valued image data for the plurality of pixels into the binary image data for the plurality of pixels by comparing said corrected multi-valued image data for the plurality of pixels with predetermined threshold values, respectively.

71. An apparatus according to claim 70, wherein said correction data is generated in advance so that a detection characteristic for said predetermined one of density and lightness in the image input device is reflected therein.

72. An apparatus for converting multi-valued image data into binary image data, where said multi-valued image data is obtained for a plurality of pixels by one of a plurality of image input devices, and said one of the plurality of image input devices detects a predetermined one of density and lightness of each pixel of an original image, said apparatus comprising:
correction data storing means for storing a plurality of sets of correction data each set being determined in advance so as to be specific to a respective one of the plurality of image input devices;
data inputting means for inputting said multi-valued image data;
instruction inputting means for inputting an instruction which indicates by which one of the plurality of image input devices said multi-valued image data is obtained;
selection means for selecting one of a plurality of sets of correction data in response to said instruction; and
correction means for converting said multi-valued image data for the plurality of pixels into corrected multi-valued image data in accordance with said one of the plurality of sets of correction data which is selected by said selection means;
conversion means for converting said corrected multi-valued image data for the plurality of pixels into the binary image data for the plurality of pixels by comparing said corrected multi-valued image data for the plurality of pixels with predetermined threshold values, respectively.

73. A computer-readable storage medium in which a program is stored, where said program, when used with a computer, directs the computer to execute a process for converting multi-valued image data into binary image data, where said multi-valued image data is obtained for a plurality of pixels by an image input device which detects a predetermined one of density and lightness of each pixel of an original image, said process comprising the steps of:
(a) inputting said multi-valued image data;
(b) inputting an instruction which indicates by which one of the plurality of image input devices said multi-valued image data is obtained;
(c) selecting one of a plurality of sets of correction data in response to said instruction, where each of said plurality of sets of correction data is determined in advance so as to be specific to a respective one of the plurality of image input devices;
(d) converting said multi-valued image data for the plurality of pixels into corrected multi-valued image data in accordance with said one of the plurality of sets of correction data which is selected in step (c); and
(e) converting said corrected multi-valued image data for the plurality of pixels into the binary image data for the plurality of pixels by comparing said corrected multi-valued image data for the plurality of pixels with predetermined threshold values, respectively.

74. A process for converting multi-valued image data into binary image data, where said binary image data is to be output as a visible output image by an image output device, said process comprising the steps of:
(a) inputting said multi-valued image data;
(b) converting said multi-valued image data for the plurality of pixels into corrected multi-valued image data in accordance with correction data which is determined in advance so as to be specific to said image output device; and
(c) converting said corrected multi-valued image data for the plurality of pixels into the binary image data for the plurality of pixels by comparing said corrected multi-valued image data for the plurality of pixels with predetermined threshold values, respectively.

75. A process according to claim 74, wherein said correction data is generated in advance so that an output characteristic of the image output device is reflected therein.

76. A process for converting multi-valued image data into binary image data, where said binary image data is to be output as a visible output image by one of a plurality of image output devices, said process comprising the steps of:
(a) inputting said multi-valued image data;
(b) inputting an instruction which indicates by which one of the at least one image output device the binary image data is to be output;
(c) selecting one of a plurality of sets of correction data in response to said instruction, where each of said plurality of sets of correction data is determined in advance so as to be specific to a respective one of the plurality of image output devices;
(d) converting said multi-valued image data for the plurality of pixels into corrected multi-valued image data in accordance with said one of the plurality of sets of correction data which is selected in step (c); and
(e) converting said corrected multi-valued image data for the plurality of pixels into the binary image data for the plurality of pixels by comparing said corrected multi-valued image data for the plurality of pixels with predetermined threshold values, respectively.

77. An apparatus for converting multi-valued image data into binary image data, where said binary image data is to be output as a visible output image by an image output device, said apparatus comprising:
data inputting means for inputting said multi-valued image data; and
correction means for converting said multi-valued image data for the plurality of pixels into corrected multi-valued image data in accordance with correction data which is determined a combination of said image input device and said image output device; and
conversion means for converting said corrected multi-valued image data for the plurality of pixels into the binary image data for the plurality of pixels by comparing said corrected multi-valued image data for the plurality of pixels with predetermined threshold values, respectively.

78. An apparatus according to claim 77, wherein said correction data is generated in advance so that an output characteristic of the image output device is reflected therein.

79. An apparatus for converting multi-valued image data into binary image data, where said binary image data is to be output as a visible output image by one of a plurality of image output devices, said apparatus comprising:
correction data storing means for storing a plurality of sets of correction data each set being determined in advance so as to be specific to a respective one of the plurality of image output devices;
data inputting means for inputting said multi-valued image data;
instruction inputting means for inputting an instruction which indicates by which one of the plurality of image output devices said binary image data is output;
selection means for selecting one of a plurality of sets of correction data in response to said instruction; and
correction means for converting said multi-valued image data for the plurality of pixels into corrected multi-valued image data in accordance with said one of the plurality of sets of correction data which is selected by said selection means;
conversion means for converting said corrected multi-valued image data for the plurality of pixels into the binary image data for the plurality of pixels by comparing said corrected multi-valued image data for the plurality of pixels with predetermined threshold values, respectively.

80. A computer-readable storage medium in which a program is stored, where said program, when used with a computer, directs the computer to execute a process for converting multi-valued image data into binary image data, where said binary image data is to be output as a visible output image by an image output device, said process comprising the steps of:
(a) inputting said multi-valued image data;
(b) inputting an instruction which indicates by which one of the at least one image output device the binary image data is to be output;
(c) selecting one of a plurality of sets of correction data in response to said instruction, where each of said plurality of sets of correction data is determined in advance so as to be specific to a respective one of the plurality of image output devices;
(d) converting said multi-valued image data for the plurality of pixels into corrected multi-valued image data in accordance with said one of the plurality of sets of correction data which is selected in step (c); and
(e) converting said corrected multi-valued image data for the plurality of pixels into the binary image data for the plurality of pixels by comparing said corrected multi-valued image data for the plurality of pixels with predetermined threshold values, respectively.

81. A process for converting multi-valued image data into binary image data, where said multi-valued image data is obtained for a plurality of pixels by an image input device which detects a predetermined one of density and lightness of each pixel of an original image, and said binary image data is to be output as a visible output image by an image output device, said process comprising the steps of:
(a) inputting said multi-valued image data;
(b) converting said multi-valued image data for the plurality of pixels into corrected multi-valued image data in accordance with correction data which is determined in advance so as to be specific to a combination of said image input device and said image output device; and
(c) converting said corrected multi-valued image data for the plurality of pixels into the binary image data for the plurality of pixels by comparing said corrected multi-valued image data for the plurality of pixels with predetermined threshold values, respectively.

82. A process according to claim 81, wherein said correction data is generated in advance so that a detection characteristic for said predetermined one of density and lightness in the image input device and an output characteristic of the image output device are reflected therein.

83. A process for converting multi-valued image data into binary image data, where said multi-valued image data is obtained for a plurality of pixels by one of at least one image input device, said one of the at least one image input device detects a predetermined one of density and lightness of each pixel of an original image, and said binary image data is to be output as a visible output image by one of at least one image output device, said process comprising the steps of:
(a) inputting said multi-valued image data;
(b) inputting an instruction which indicates by which one of a plurality of combinations of the at least one image input device and the at least one image output device said multi-valued image data is obtained and said binary image data is to be output, respectively;
(c) selecting one of a plurality of sets of correction data in response to said instruction, where each of said plurality of sets of correction data is determined in advance so as to be specific to a respective one of a plurality of possible combinations of the at least one image input device and the at least one image output device;
(d) converting said multi-valued image data for the plurality of pixels into corrected multi-valued image data in accordance with said one of the plurality of sets of correction data which is selected in step (c); and
(e) converting said corrected multi-valued image data for the plurality of pixels into the binary image data for the plurality of pixels by comparing said corrected multi-valued image data for the plurality of pixels with predetermined threshold values, respectively.

84. An apparatus for converting multi-valued image data into binary image data, where said multi-valued image data is obtained for a plurality of pixels by an image input device which detects a predetermined one of density and lightness of each pixel of an original image, and said binary image data is to be output as a visible output image by an image output device, said apparatus comprising:
data inputting means for inputting said multi-valued image data; and
correction means for converting said multi-valued image data for the plurality of pixels into corrected multi-valued image data in accordance with correction data which is determined a combination of said image input device and said image output device; and
conversion means for converting said corrected multi-valued image data for the plurality of pixels into the binary image data for the plurality of pixels by comparing said corrected multi-valued image data for the plurality of pixels with predetermined threshold values, respectively.

85. An apparatus according to claim 84, wherein said correction data is generated in advance so that a detection characteristic for said predetermined one of density and lightness in the image input device and an output characteristic of the image output device are reflected therein.

86. An apparatus for converting multi-valued image data into binary image data, where said multi-valued image data is obtained for a plurality of pixels by one of at least one image input device, said one of the at least one image input device detects a predetermined one of density and lightness of each pixel of an original image, and said binary image data is to be output as a visible output image by one of at least one image output device, said apparatus comprising:
correction data storing means for storing a plurality of sets of correction data each set being determined in advance so as to be specific to a respective one of a plurality of possible combinations of the at least one image input device and the at least one image output device;
data inputting means for inputting said multi-valued image data;
instruction inputting means for inputting an instruction which indicates by which one of a plurality of combinations of the at least one image input device and the at least one image output device said multi-valued image data is obtained and said binary image data is to be output, respectively;
selection means for selecting one of a plurality of sets of correction data in response to said instruction; and
correction means for converting said multi-valued image data for the plurality of pixels into corrected multi-valued image data in accordance with said one of the plurality of sets of correction data which is selected by said selection means;
conversion means for converting said corrected multi-valued image data for the plurality of pixels into the binary image data for the plurality of pixels by comparing said corrected multi-valued image data for the plurality of pixels with predetermined threshold values, respectively.

87. A computer-readable storage medium in which a program is stored, where said program, when used with a computer, directs the computer to execute a process for converting multi-valued image data into binary image data, where said multi-valued image data is obtained for a plurality of pixels by at least one image input device which detects a predetermined one of density and lightness of each pixel of an original image, and said binary image data is to be output as a visible output image by at least one image output device, said process comprising the steps of:
(a) inputting said multi-valued image data;
(b) inputting an instruction which indicates by which one of a plurality of combinations of the at least one image input device and the at least one image output device said multi-valued image data is obtained and said binary image data is to be output, respectively;
(c) selecting one of a plurality of sets of correction data in response to said instruction, where each of said plurality of sets of correction data is determined in advance so as to be specific to a respective one of a plurality of possible combinations of the at least one image input device and the at least one image output device;
(d) converting said multi-valued image data for the plurality of pixels into corrected multi-valued image data in accordance with said one of the plurality of sets of correction data which is selected in step (c); and
(e) converting said corrected multi-valued image data for the plurality of pixels into the binary image data for the plurality of pixels by comparing said corrected multi-valued image data for the plurality of pixels with predetermined threshold values, respectively.

88. A process for converting multi-valued image data into binary image data, where said multi-valued image data is obtained for a plurality of pixels by one of at least one image input device, said one of the at least one image input device detects a predetermined one of density and lightness of each pixel of an original image, and said binary image data is to be output as a visible output image by one of at least one image output device, said process comprising the steps of:
(a) inputting said multi-valued image data;
(b) inputting an instruction containing first information which indicates by which one of the at least one image input device said multi-valued image data is obtained, and second information which indicates by which one of the at least one image output device said binary image data is to be output;
(c) selecting one of at least one first set of correction data in response to said first information, and selecting one of at least one second set of correction data in response to said second information, where each of said at least one first set of correction data is determined in advance so as to be specific to a respective one of the at least one image input device, and each of said at least one second set of correction data is determined in advance so as to be specific to a respective one of the at least one image output device;
(d) converting said multi-valued image data for the plurality of pixels into corrected multi-valued image data in accordance with the first and second sets of correction data which are selected in step (c); and
(e) converting said corrected multi-valued image data for the plurality of pixels into the binary image data for the plurality of pixels by comparing said corrected multi-valued image data for the plurality of pixels with predetermined threshold values, respectively.

89. An apparatus for converting multi-valued image data into binary image data, where said multi-valued image data is obtained for a plurality of pixels by one of at least one image input device, said one of the at least one image input device detects a predetermined one of density and lightness of each pixel of an original image, and said binary image data is to be output as a visible output image by one of at least one image output device, said apparatus comprising:
correction data storing means for storing at least one first set of correction data and at least one second set of correction data, where each of said at least one first set of correction data is determined in advance so as to be specific to a respective one of the at least one image input device, and each of said at least one second set of correction data is determined in advance so as to be specific to a respective one of the at least one image output device;
data inputting means for inputting said multi-valued image data;
instruction inputting means for inputting an instruction containing first information which indicates by which one of the at least one image input device said multi-valued image data is obtained, and second information which indicates by which one of the at least one image output device said binary image data is to be output;
selection means for selecting one of at least one first set of correction data in response to said first information, and selecting one of at least one second set of correction data in response to said second information; and
correction means for converting said multi-valued image data for the plurality of pixels into corrected multi-valued image data in accordance with the first and second sets of correction data which are selected by said selection means;
conversion means for converting said corrected multi-valued image data for the plurality of pixels into the binary image data for the plurality of pixels by comparing said corrected multi-valued image data for the plurality of pixels with predetermined threshold values, respectively.

90. A computer-readable storage medium in which a program is stored, where said program, when used with a computer, directs the computer to execute a process for converting multi-valued image data into binary image data, where said multi-valued image data is obtained for a plurality of pixels by at least one image input device which detects a predetermined one of density and lightness of each pixel of an original image, and said binary image data is to be output as a visible output image by at least one image output device, said process comprising the steps of:
(a) inputting said multi-valued image data;
(b) inputting an instruction containing first information which indicates by which one of the at least one image input device said multi-valued image data is obtained, and second information which indicates by which one of the at least one image output device said binary image data is to be output;
(c) selecting one of at least one first set of correction data in response to said first information, and selecting one of at least one second set of correction data in response to said second information, where each of said at least one first set of correction data is determined in advance so as to be specific to a respective one of the at least one image input device, and each of said at least one second set of correction data is determined in advance so as to be specific to a respective one of the at least one image output device;
(d) converting said multi-valued image data for the plurality of pixels into corrected multi-valued image data in accordance with the first and second sets of correction data which are selected in step (c); and
(e) converting said corrected multi-valued image data for the plurality of pixels into the binary image data for the plurality of pixels by comparing said corrected multi-valued image data for the plurality of pixels with predetermined threshold values, respectively.
